(19) United States
(12) Patent Application Publication
(10) Pub. No.: US 2003/0014265 A1
(43) Pub. Date: Jan. 16, 2003

(54) Online dispute resolution method and system

(76) Inventors: Aubert Landry, Montreal (CA); Joelle Thibault, Montreal (CA)

Correspondence Address: SKJERVEN MORRILL LLP, 25 METRO DRIVE, SUITE 700, SAN JOSE, CA, 95110, US

(21) Appl. No.: 09/727,574

(22) Filed: Nov. 30, 2000

(51) Int. Cl. G06F 17/60

(52) U.S. Cl. 705/1

(57) ABSTRACT

A method and system for performing online dispute resolution (“ODR”) via a central ODR Web site. Two ODR processes are disclosed. First, a NEGO-MED-ARB System provides an integrated negotiation, mediation and arbitration dispute resolution solution to customers and merchants conducted online. The NEGO-MED-ARB System enables an authorized merchant to link its e-commerce Web site to the dispute resolution services centralized on the ODR Web site. The link is performed by a distinctive, recognizable Trust Mark displayed on the e-commerce Web site and identifying the ODR services; a consumer browsing the e-commerce Web site hyperlinks to the ODR Web site by clicking on the Trust Mark. The ODR Web site then provides an online framework for the parties to exchange information and proposed solutions for resolving their dispute. Qualified mediators/arbitrators are appointed to resolve disputes online which the parties are unable to settle by themselves. Second, a Negotiation/Mediation/Arbitration System provides ODR services to any parties who agree to use it. A contract clause providing for such an agreement is made available on the ODR Web site for parties to insert in their contracts. The parties may agree to use one or more ODR services, including negotiation, mediation or arbitration; the mediation and arbitration is performed online by qualified mediators and arbitrators.

### FIELD OF THE INVENTION

This invention relates to alternative dispute resolution (“ADR”) services and, in particular, to a computer-implemented system and method of providing online dispute resolution (“ODR”) services over a computer network.

### BACKGROUND

The growth of the Internet as a means for transacting in goods and services (“e-commerce”) is well known. The increase in disputes arising from e-commerce is also well known. Certain complexities characterize disputes arising in e-commerce that are not normally related to disputes arising in ordinary transactions. For instance, it is not uncommon for two parties to reside in different countries where different legal standards apply to the same transaction. In this situation, no legal remedy generally exists or is expected, and the parties to the e-commerce transaction typically rely upon each other's good will. In the business to consumer e-commerce context, this situation often means that the consumer's only resort in the event of a dispute is the merchant's standard customer service procedures (an often unsatisfactory solution for the consumer). In other e-commerce contexts, such as when the parties reside sufficiently proximate to make litigation available, the same situation (i.e., no practical dispute resolution alternative) often results. For a large category of cases in this transactional context, the excessive distance between the parties and the relatively minor value of the transaction (especially in consumer transactions) render litigation and traditional ADR processes prohibitively expensive. This situation is exacerbated by the uncertainty of nascent commercial e-commerce standards and the often complex jurisdictional and choice of law issues that arise in an e-commerce dispute. The result of this enhanced legal uncertainty and complexity is to render traditional dispute resolution measures (i.e., litigation and ADR) even less feasible, especially for the large class of cases where the value of the transaction does not justify substantial expenditure. Consequently, parties to e-commerce transactions typically do not expect recourse to a neutral, third party dispute resolution process, and expect instead to assume a level of risk for transactional failure beyond that normally assumed in traditional commercial contexts.

The practical effect of this situation on e-commerce is to dampen growth. Parties are reluctant to engage in e-commerce because of the increased risk of transactional failure caused by the absence of meaningful remedies. E-merchants thus lose substantial revenue. The present invention addresses these and other problems.

### SUMMARY

A computer-implemented online dispute resolution method and system (“ODR System”) for application over a computer network is disclosed herein. In some embodiments, the ODR System comprises two sub-systems: the NEGO-MED-ARB System and the Negotiation/Mediation/Arbitration System. The NEGO-MED-ARB System provides a cost-effective, expedited online dispute resolution service that integrates aspects of traditional negotiation, mediation and arbitration alternate dispute resolution processes. It is primarily directed (but not limited) to customer disputes with merchants over commercial transactions having monetary values which do not justify dispute resolution using traditional methods (e.g., litigation, traditional alternate dispute resolution processes). The Negotiation/Mediation/Arbitration System provides a more traditional (i.e., more detailed and less expedited) yet customizable online dispute resolution solution to any parties that agree to use the system. It is primarily directed (but not limited) to merchant to merchant disputes. Both systems use a central Web site for providing a structured environment and centralized access point for performing online dispute resolution services.

In some embodiments, the NEGO-MED-ARB System includes a trust mark program. In this program, a merchant enrolls to become a merchant-partner authorized to use a ODR System hyperlink. The merchant-partner displays the ODR System hyperlink on its merchant Web site to inform customers accessing the merchant Web site that it is providing the ODR System as a value-added service. Customers may then click on the ODR System hyperlink to immediately hyperlink to the NEGO-MED-ARB System on the ODR System Web site. In some embodiments, the customer initiates the NEGO-MED-ARB System services by completing online electronic forms (Application Form) with his or her version of the facts of the dispute and one or more solutions proposed by the customer for resolving the dispute. This customer-provided information, including the customer's proposed solutions, is then provided to the merchant-partner, who may accept one of the proposed solutions to resolve the dispute. In some embodiments, if the merchant-partner does not accept one of the proposals, he or she completes the online forms with his or her own version of the dispute, and then provides one or more proposals to resolve the dispute. This merchant-partner-provided information, including the merchant-partner's proposed solutions, is then provided to the customer, who may accept one of the proposed solutions to resolve the dispute. In some embodiments, if the customer does not accept one of the proposed solutions, then a mediator is appointed to resolve the dispute. The mediator proposes three solutions to the dispute after review of the proposals made by the parties and other relevant dispute-related information. If the parties agree to one of the mediator's proposals, then the dispute is resolved; otherwise, the mediator analyzes the record of the dispute, including the parties' responses to the mediator's proposed solutions, and drafts a proposed final solution to resolve the dispute. In some embodiments, the parties will have agreed beforehand to be bound by the mediator's final solution, in which case the proposed final solution may operate as an arbitration award. In some embodiments, the merchant-partner has agreed beforehand with the ODR System owner to accept the proposed final solution; in these embodiments, the proposed final solution as applied to the merchant-partner may also operate as a form of arbitration award. In some embodiments, the parties may at anytime during the dispute resolution process propose a solution via the NEGO-MED-ARB System to the other party to settle the dispute.

In some embodiments, the events constituting the NEGO-MED-ARB System occur within a structured time-sensitive framework. In some embodiments, the time period between the customer's first submitting a proposed solution to the dispute to the NEGO-MED-ARB System and the merchant-partner's response is seven days. In some embodiments, the time period between the merchant-partner's submitting a proposed solution (after rejecting the customer's proposed solutions) and the customer's response is ten days. In some embodiments, the time period between the start of mediation (after the parties reject each other's proposed solutions) and delivery of the proposed solutions as determined by the mediator is sixteen days. In some embodiments, the time period between the start of arbitration (after the parties reject the mediator's proposed solutions) and delivery of the proposed final solution is twenty-four days. Thus, in some embodiments, unless the parities agree to an earlier resolution, the integrated dispute resolution package provided by the NEGO-MED-ARB System completes in twenty-four days.

Other variations to the above embodiments are also described.

### BRIEF DESCRIPTION OF THE DRAWINGS

FIG. 1A is a block diagram illustrating a client/server computing environment over a global-area network.

FIG. 1B is a block diagram illustrating a Web-based client/server computing environment.

FIG. 1C is a block diagram illustrating the process logic of a dynamic Web service, according to some embodiments of the invention.

FIG. 1D is a block diagram illustrating the ODR System in a Web-based client/server environment, according to some embodiments of the invention.

FIG. 2A is a block diagram illustrating the principal interactions performed on the ODR System by human agents, according to some embodiments of the invention.

FIG. 2B is a block diagram of the major components of the ODR System, according to some embodiments of the invention.

FIG. 3A is a high-level flow diagram illustrating the logic sequence of the NEGO-MED-ARB System, according to some embodiments of the present invention.

FIG. 3B is a flow diagram illustrating the Merchant Enrollment Process of the NEGO-MED-ARB System, according to some embodiments of the invention.

FIGS. 3C(1) to 3C(7) are flow diagrams illustrating the NEGO-MED-ARB System, according to some embodiments of the invention.

FIG. 3D is a flow diagram illustrating the Parallel Negotiation Process of the NEGO-MED-ARB System, according to some embodiments of the invention.

FIG. 3E is a flow diagram illustrating the Mediator Appointment Process of the NEGO-MED-ARB System, according to some embodiments of the invention.

FIG. 4A is a flow diagram illustrating the process logic of the Negotiation/Mediation/Arbitration Service, according to some embodiments of the invention.

FIG. 4B is a flow diagram illustrating the stages in the mediator and arbitrator appointment process in the Negotiation/Meditation/Arbitration System according to some embodiments of the invention.

### DETAILED DESCRIPTION

ODR System Programming Overview

For purposes of this discussion, it should be understood that the systems, methods, processes, programs, and the like described herein are not related to or limited by any particular computer, apparatus, or computer language. Rather, various types of general purpose computing machines or devices can be used for implementing the teachings described herein, some of which are described below. In addition, it should be understood that the programs, processes, methods, and the like described herein, are not limited to a specific software or hardware implementation. Rather, it may prove advantageous, for example, to implement one or more processes in hardware, one or more in code operating from non-volatile memory such as a read-only memory (ROM), or one or more processes in code operating from volatile memory such as a random-access memory (RAM). In addition, it should be understood that although the current embodiment uses primarily World Wide Web (hereafter, “Web”) technology to communicate information and functionality over a computer network, other embodiments might use other document types and dissemination technologies. For example, instead of requesting HTML documents with a Web browser, documents may be transmitted and received by means of email disseminated by a mail server, or PUSH documents disseminated by a PUSH server. Other technologies such as video-on-demand or video-conferencing may also provide effective means for disseminating ODR System-related information. In short, the present invention should not be understood as related to or limited by a particular machine, a particular hardware/software implementation, or a particular technology for information dissemination over a computer network.

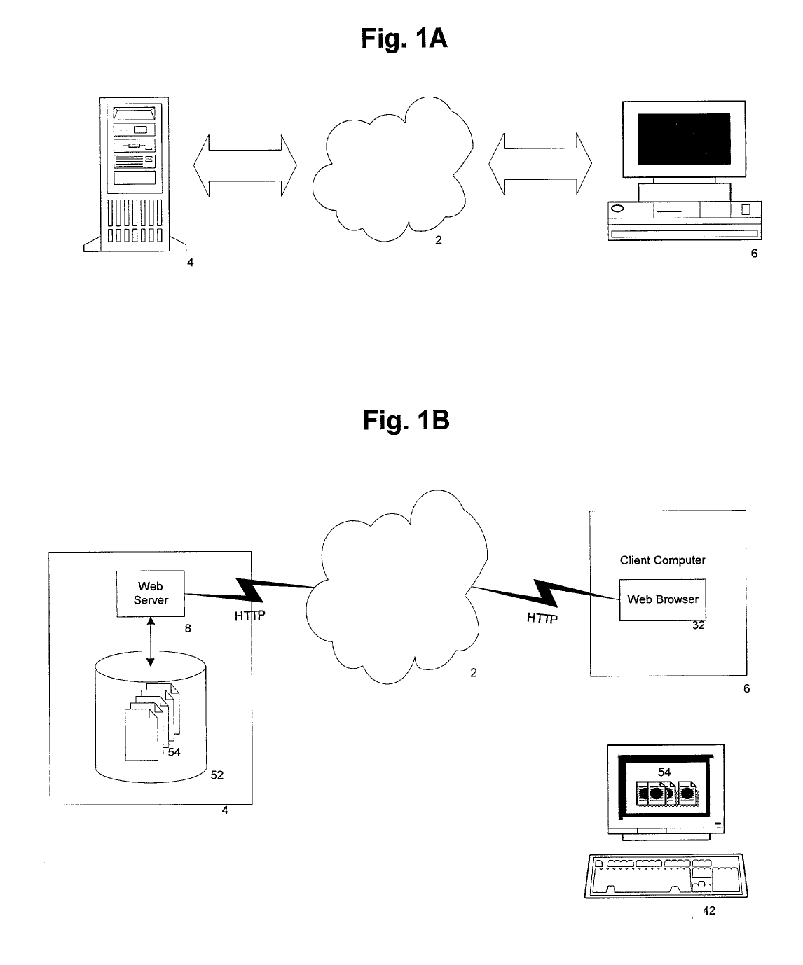

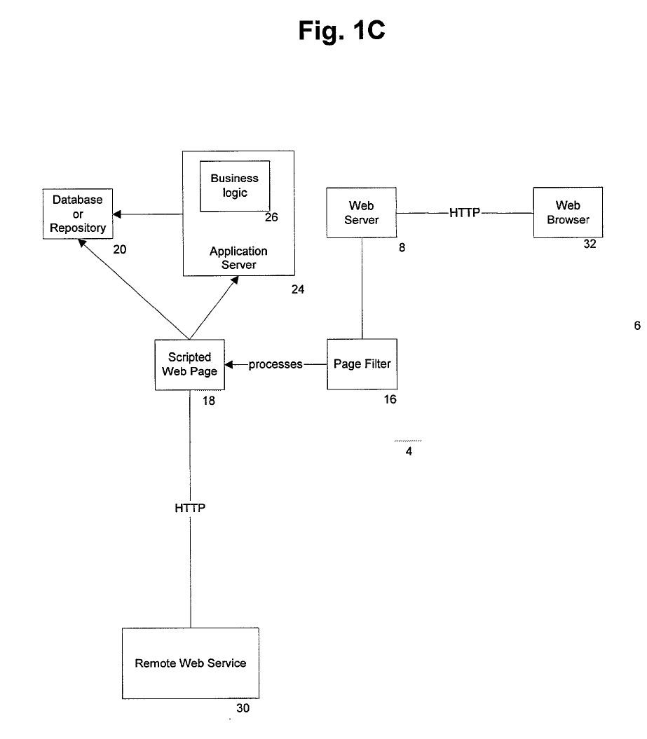

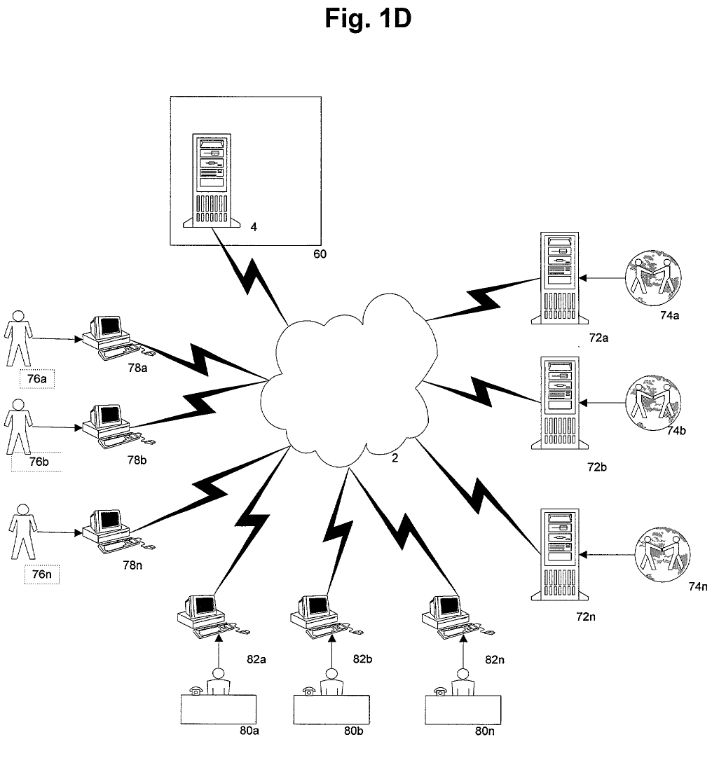

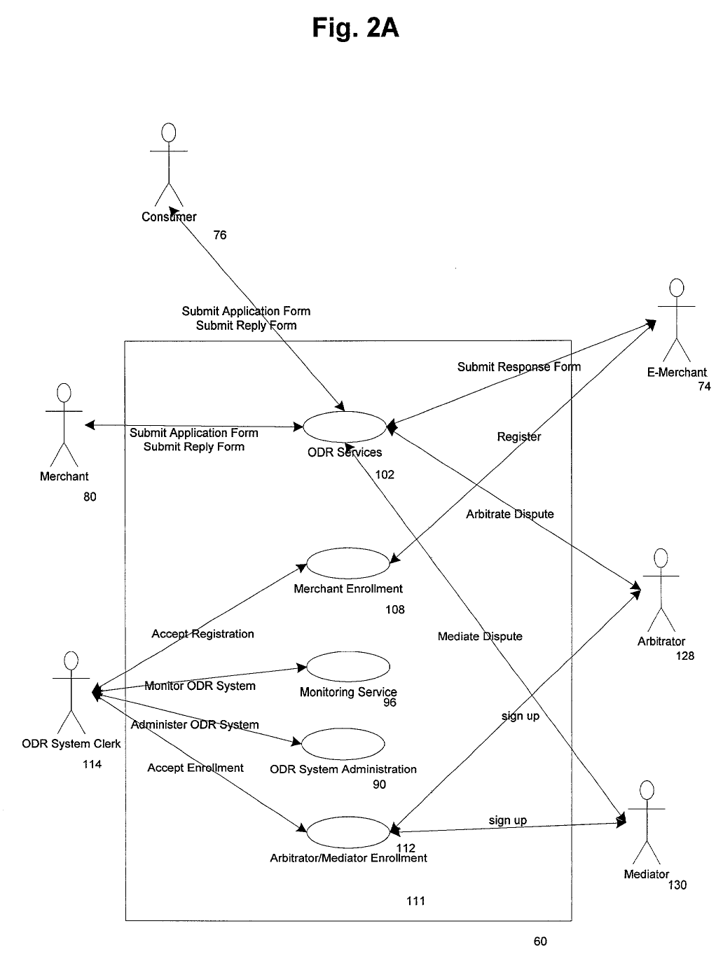

FIG. 1A is a block diagram illustrating a client/server computing environment over a global-area network (e.g., the Internet). A host computer 4 operating a server process is connected to a client computer 6 operating a client process via computer network 2. Computer network 2 may include, by way of example, a global-area network (the Internet), a wide area network (WAN), a local area network (LAN), a wireless network, and the like. Typically, the client process sends an electronic request over the computer network 2 which is received and processed by a server process running on host computer 4. After processing the request, the server process returns the result—-such as requested information—back to the client process, where it may then be made available to a human user. The terms “client” and “server” are functional descriptions, and a single machine may operate both client and server process. Client and server processes communicate with each other over a computer network using one or more shared communication protocols, for example, HTTP (the Web), SMTP and LDAP (messaging), and WAP (wireless), typically built over lower-level TCP/IP protocols (the Internet). Embodiments of the present invention may generally be adapted for use with any conventional communication protocol using conventional programming techniques.

FIG. 1B is a block diagram illustrating a client/server computing environment as applied to the Web. Host computer 4 operating Web server 46 is connected to a client computer 6 operating a Web browser 32. Web server 46 and Web browser 32 transfer information—including data and processing logic—over computer network 2 using standard Web protocols (i.e., HTTP over TCP/IP). On the server side, Web server 46 processes Web browser 32 requests by, for example, retrieving Web pages 54 (i.e., typically HTML- or XML-encoded information) from one or more storage devices 52 for distribution to Web browser 32. Web browser 32 in turn may render Web pages 54 as graphical objects 54 on viewing device 42 in accordance with their HTML/XML encoding. Web page information may include text, scripts, graphics, animations, videos, and hyperlinks. A Web site typically comprises one or more Web pages 54 organized by a particular process logic running on host computer 4. Each Web page 54 has a unique identifier (URL); a Web browser identifies a particular Web page 54 in a request sent to a server using the URL. Users typically navigate through Web pages 54 using hyperlinks encoded in the Web pages 54 that embed URL's to other Web pages 54; a user merely activates a hyperlink—typically by clicking the hyperlink on a viewing device with a pointing device—to retrieve the particular Web page 54 provided by the hyperlink. FIGS. 1A and 1B show a single host computer connected to a single client computer for illustrative purposes only; the Internet and the Web actually comprise millions of interconnected host and client computers.

FIG. 1C is a block diagram illustrating the process logic of a dynamic Web service, according to some embodiments of the invention. A dynamic Web service, as defined herein, provides dynamic content delivery and processing capacity to client processes, such as Web browsers 32 and other (e.g., remote) Web services 30. Client processes are thus able to alter the state of the business logic associated with the Web service, and server processes are able to dynamically control content in response to client behavior. Turning to FIG. 1C, dynamic Web service functionality is provided by processing logic operating on a host computer. Processing logic includes Web server 8, page filter 16, business logic 26, application server 24 and database server 20. Processing logic may operate on one or more host computers, and in complex applications, the application server 24 and business logic 26 may operate on a middle tier of components. In some embodiments, dynamic Web content delivery and processing capacity is provided by embedding process logic in Web pages, and executing the process logic during Web page retrieval by Web server 8; this may be implemented using page filter 16 to interpret and execute Web page program logic during runtime. In some embodiments, Web page program logic may be written in a scripting language, such as PERL, JavaScript, or VBScript, using well-known CGI protocols for communicating with other application servers, such as a database server. Some embodiments may provide dynamic processing capacity using well-known server-side technologies such as JSP (Java Server Pages), servlets, or EJB (Enterprise Java Beans) technologies—all produced by Sun Corporation of Mountain View, Calif.—or ASP (Active Server Pages)—produced by Microsoft Corporation of Redmond, Wash. In some embodiments, the ODR System application servers and business logic may be implemented using COM+ objects (produced by Microsoft Corporation) and data distributed from one or more application servers 24; in some embodiments, application servers may include database server 20 using ADO (Active Data Objects), OLE DB (OLE DataBase), or ODBC (Open Database Connectivity) and COM (Component Object Model) interfaces and objects—all produced by Microsoft Corporation. In some embodiments, application servers may issue HTTP requests to other Web services 30 operating locally or on remote hosts connected by the Web using SOAP (Simple Object Access Protocol) and XML technologies.

Web server 44 may be any special or general purpose computer suitable for maintaining a Web site, including as a Pentium-based computer available from a variety of third-parties, an UltraSparc workstation, available from Sun Microsystems, Inc. of Mountain View, Calif., or an RS6000 workstation, available from IBM of White Plains, N.Y. Client computer 6 can be any special or general purpose computer suitable for accessing a Web site over the Internet 2, such as any Pentium-based desktop computer available from a variety of third-parties or a Macintosh computer available from Apple Computer, Inc. of Cupertino, Calif. Web browser 32 is any Web browser suitable for making requests to Web servers 44 and rendering HTML documents 54 for display as graphical objects 36, such as Internet Explorer 4.0 or 5.0, available from Microsoft Corporation of Redmond, Wash., or Netscape Navigator 4.0 or 5.0, available from Netscape Communications of Mountain View, Calif. Web server program 46 is any Web server program capable of processing HTTP requests from Web browsers 32, such as the Windows 2000 Server running IIS 5.0 or Site Server, with ASP and SQL Server 2000 (available from Microsoft Corporation of Redmond, Wash.), Java Web Server, available from Sun Microsystems of Mountain View, Calif., or the Apache Web Server, available from Apache Software Foundation of Forest Hill, Md.

FIG. 1D is a block diagram illustrating the ODR System 60 in a Web-based client/server environment, according to some embodiments of the invention. The ODR System 44 operates on host computer 44 connected to Web 34. Host computer 44 executes a computer program (hereafter, “ODR System Program”) comprising the process logic of the ODR System, including logic for maintaining a dedicated ODR Web site (hereafter, “ODR System Web site”). Consumers 76n [where n=a, b, c, . . . ] and merchants 80n [where n=a, b, c, . . . ] access the ODR System via the ODR System Web site from client computers 78n [where n=a, b, c, . . . ] and 82n [where n=a, b, c, . . . ]. E-merchants 74n [where n=a, b, c, . . . ] operate e-commerce Web sites on host computers 72n [where n=a, b, c, . . . ]. In this manner, consumers 76n and merchants 80n make commercial transactions at e-commerce Web sites 72n with E-merchants 74n over computer network 2. Furthermore, because the physical location of each party to a transaction is often not apparent, e-commerce transactions often take place over great distances from one or more legal jurisdictions. For the same reason—the irrelevancy of the physical location of the ODR System 60 in a computer network—disputes arising over an e-commerce transaction may be efficiently resolved by consumers, merchants and e-merchants accessing and employing the ODR System 60.

ODR System Overview

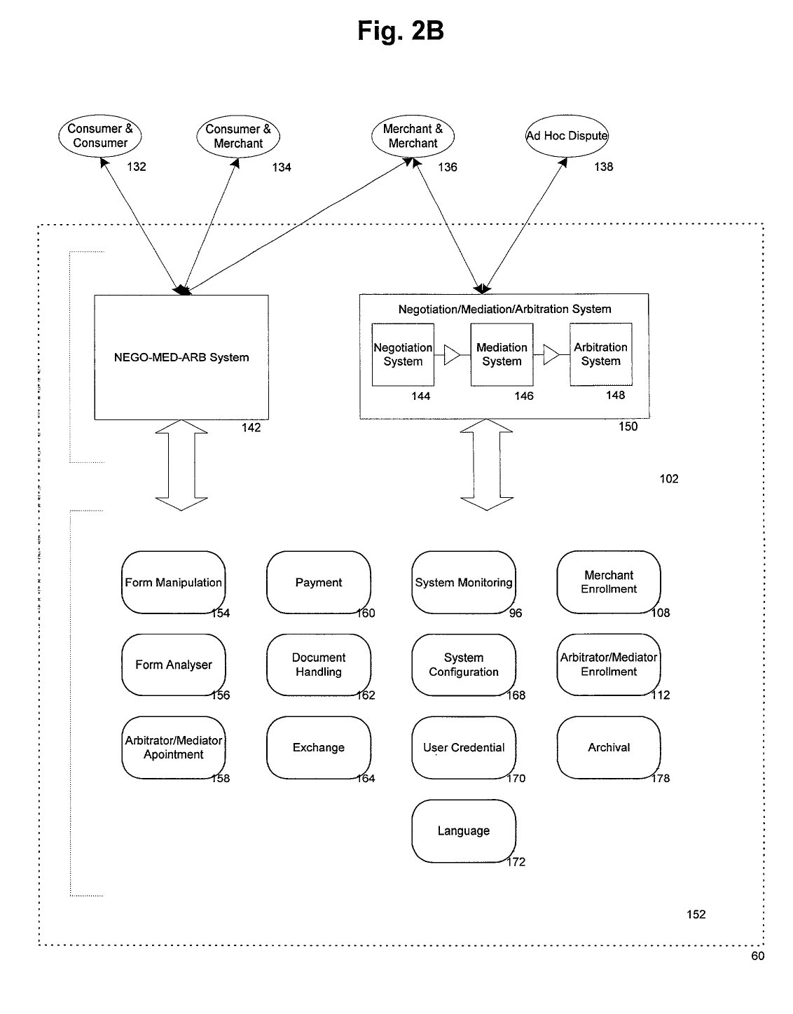

FIG. 2A is a block diagram illustrating the principal human interactions performed on the ODR System 60, according to some embodiments of the invention. Human agents typically interacting with the ODR System include consumers 120, merchants 80 (an online buyer of goods or services), e-merchants 74 (an online seller of goods or services), mediators 130, arbitrators 128, and the ODR System Clerk 114. The principal functionalities of the ODR System engaged by human agents include the ODR services 102, e-merchant enrollment 108, monitoring service 96, system administration 90, and arbitrator/mediator enrollment 112. ODR services 102 are accessed by consumers 76, merchants 80, e-merchants 74, arbitrators 128, and mediators 130. ODR services 102 typically involve an exchange of information between the parties to a dispute. The exchange generally consists of the parties providing information in the following order: the party bringing the dispute (“initiating party”), the party the dispute is brought against (“opposing party”), and again the initiating party. In some embodiments of the invention, this ordered exchange of information is provided by completing and submitting online forms containing the information. Thus, the initiating party typically submits an Application Form containing information relating to the dispute; the opposing party then responds to the Application Form by submitting a Response Form relating information which tells its view of the dispute; the initiating party may then submit a Reply Form which responds to the Response Form. E-merchants 74, in contrast to consumers 76 and merchants 80, additionally access merchant enrollment 108 in order to register as merchant-partners with the ODR System 60 (merchant enrollment 108 is described in detail below). It should be noted that FIG. 2A does not show all of the interactions shown by the parties, but provides only an overview of the more important interactions; for example, e-merchants 74 and merchants 80 during Negotiation/Meditation/Arbitration processes (described below) may perform the same or similar interactions that consumers 76 perform as initiating parties, although this interaction is not shown on FIG. 2a. In addition to consumer 76, merchant 80 and e-merchant 74 interactions, arbitrators 128 and mediators 130 also interact with ODR services 102 by performing the actual mediation and arbitration between the parties.

Other ODR System 60 services interacted by human agents include merchant enrollment 108, monitoring service 96, system administration 90 and arbitrator/mediator enrollment 112. Mediators 130 and arbitrators 128 access arbitrator/mediator enrollment services (described in detail below) to become eligible for performing online arbitration/mediation. The System Clerk 114 (“Clerk”) accesses all of the ODR System services (except the ODR services 102) for purposes of globally maintaining and monitoring the ODR System 60 processes, registering e-merchants, and enrolling mediators and arbitrators; these system services include merchant enrollment 108, monitoring service 96, system administration 90, and arbitrator/mediator enrollment 112. The Clerk 114 is responsible for administering the ODR System 60 using the system administration service 90; this service enables the Clerk 114 to administer access rights, manage multi-lingual interfaces, and manage archived materials. The Clerk 114 accepts the registration of mediators 130 and arbitrators 128 into the ODR System 60 using the arbitrator/mediator enrollment service 112 (the arbitrator/mediator enrollment service 112 is described in detail below). The Clerk 114 accepts the registration of merchants 80 in the ODR System 60 using the merchant enrollment service 108 (described in detail below). The Clerk 114 monitors the ODR System processes using monitoring service 96; this service enables the Clerk to verify the validity of the Arbitration/Mediation Clause (discussed below), and to generally provide support to parties during ODR processes (e.g., providing assistance in completing and submitting electronic forms).

FIG. 2B is a block diagram of the major components of the ODR System 60, according to some embodiments of the invention. ODR System 60 comprises two sub-systems: ODR Services 102 and System Services 152. ODR Services 102 further comprises two sub-systems: the NEGO-MED-ARB System 142 and the Negotiation/Meditation/Arbitration System 150. The two ODR sub-Systems—the NEGO-MED-ARB System 142 and the Negotiation/Mediation/Arbitration System 150—are designed to handle different types of disputes. In particular, the NEGO-MED-ARB System 142 is designed for disputes of any value arising between consumers and merchants 134, and for disputes of small monetary value arising between merchants and other merchants (merchant & merchant) 136. (Note that a “merchant” here may refer to any seller of goods, for example, an individual selling an item in an online auction.) Thus, the NEGO-MED-ARB System 142 generally targets the needs for a low cost dispute resolution solution typically involving disputes of small monetary value. The Negotiation/Meditation/Arbitration System 150, on the contrary, is designed for disputes of generally greater monetary value arising between merchants (whether merchants or e-merchants) 136, and for disputes in an ad hoc context (“ad hoc disputes”) arising between any two parties (individual or corporate) 138. An ad hoc dispute is one in which the parties are not previously bound by prior agreement to a particular ODR service provider. In some embodiments of the invention, the Negotiation/Meditation/Arbitration System 150 further comprises three sub-systems: the negotiation system 144, the mediation system 146 and the arbitration system 148. The Negotiation/Meditation/Arbitration System 150 may be customized to fulfill the specific needs of the parties to the dispute; parties may select, for example, any of the three sub-systems (negotiation system 144, mediation system 146, arbitration system 148) alone or in combination. Thus, for example, parties may agree to use only the negotiation 144 and mediation 146 systems for one dispute, and the arbitration 148 system for another dispute.

The NEGO-MED-ARB System 142 and Negotiation/Meditation/Arbitration System 150 both depend upon and use the process logic of the System Service 152 system for operation. The System Services 152 system includes process logic for the following services: form manipulation 154, payment 160, system monitoring 96, merchant enrollment 108, form analyzer 156, document handling 162, system configuration 168, arbitrator/mediator enrollment 112, arbitrator/mediator appointment 158, exchange 164, user credential 170, archival 178, language 172. A brief description of these services follows. The form manipulation service 154 enables the navigation, display, editing, and validation of a electronic form, such as the Application Form, the Response Form, the Reply Form, and the Agreement Form. The form analyzer services 156 analyzes the parties' response to proposed solutions, and generates an Agreement Form according to the result of such analysis. The Mediator/Arbitrator Appointment Services 158 manages the appointment of the mediators and arbitrators to a case according to, in part, the preferred characteristics provided by the parties. The payment services 160 implements secure fee payment from the parties. The document handling services 162 enables the ODR System 60 to handle documents in a wide range of formats: emails, word processor documents, faxes, scanned documents such as photographs and hand written documents, audio/visual material. The document handling service 162 also facilitates the indexing, searching, amendment, exchange, storage and retrieval of documents associated with ODR services 102. The exchange services 164 enables parties to have private online hearings and deliberations using, for example, integrated private chat rooms or integrated private net meetings. The system monitoring services 166 enables the System Clerk to view information needed for assisting parties in the ODR proceedings. The system configuration services 168 enables customization of ODR services 102 to the specific needs of the parties. The user credential services 170 enables the ODR System 60 to provide a secure and reliable working environment for the parties; it provides user authentication and administers access rights to the parties. The language services 172 enables the ODR System 60 to offer ODR services in multiple languages. The merchant enrollment services 174 enables the ODR System 60 to authorize a merchant-partner to use a trust mark (discussed in detail below). The mediator and arbitrator enrollment services 176 enables the ODR System 60 to enroll and administer qualified mediators and arbitrators. And lastly the archival service 178 enables the ODR System 60 to archive or delete archived dispute and user information. The ODR Service systems and relevant System Services 152 component services are described in detail below.

The NEGO-MED-ARB System

1. NEGO-MED-ARB System Overview

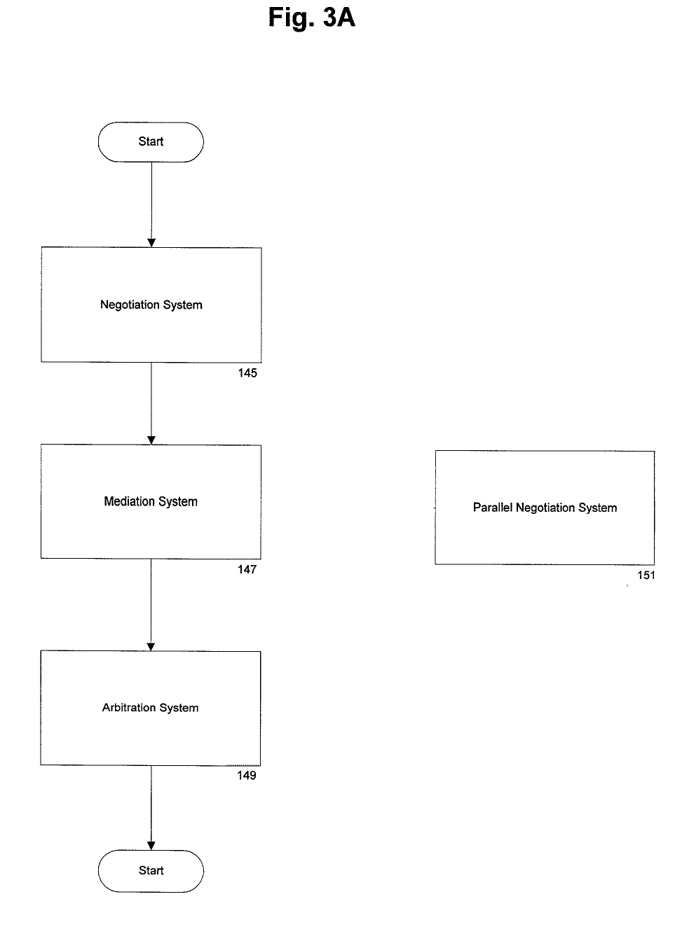

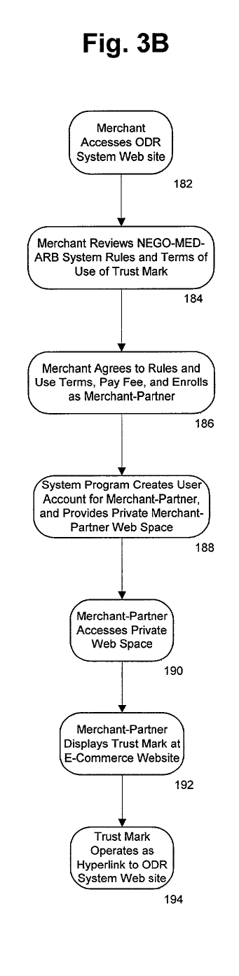

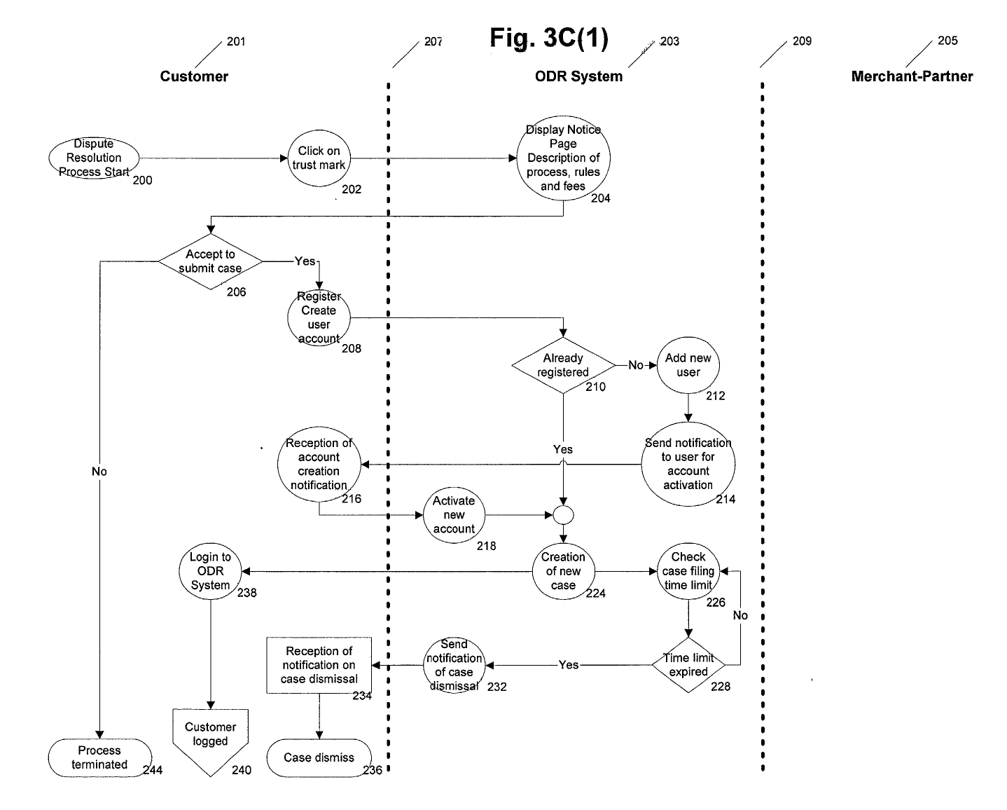

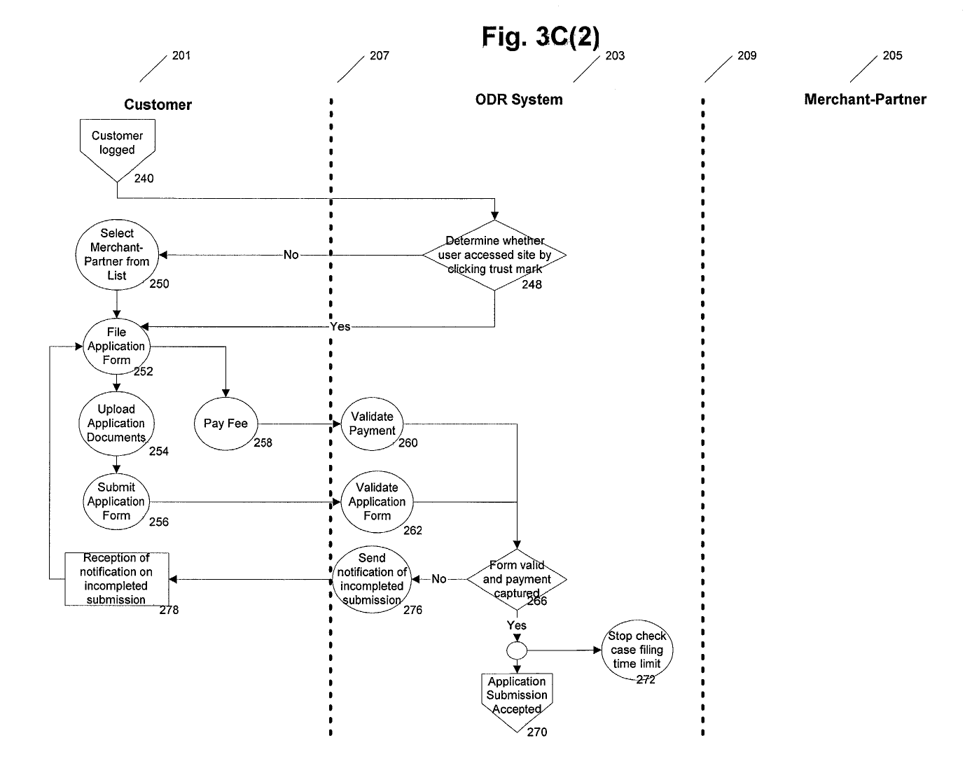

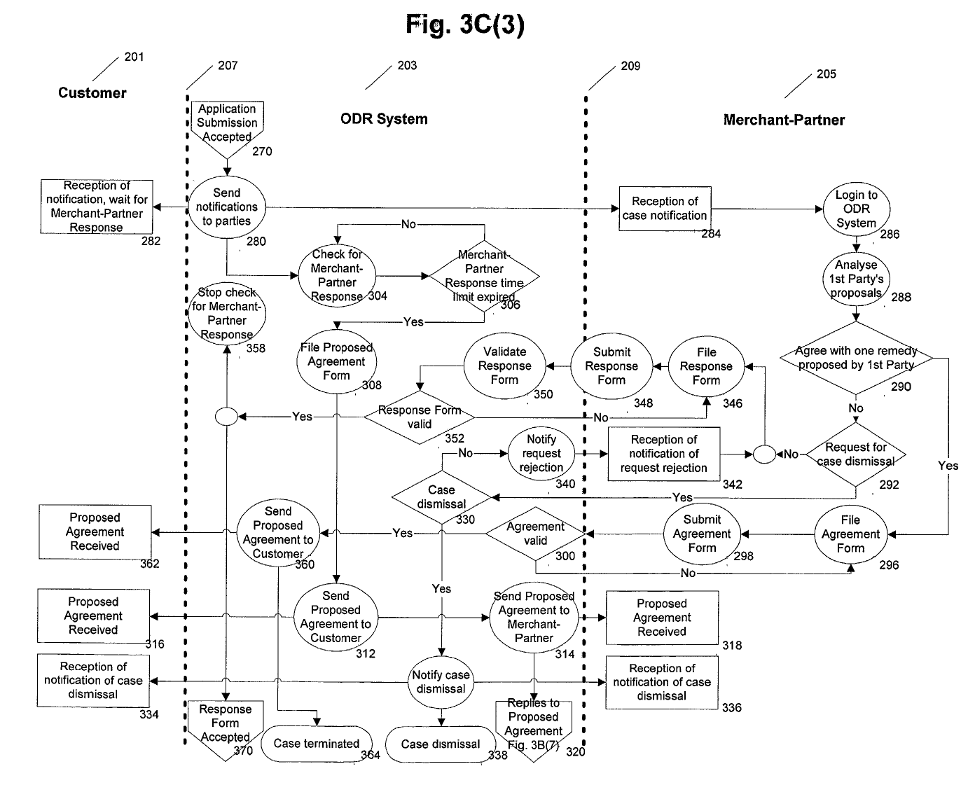

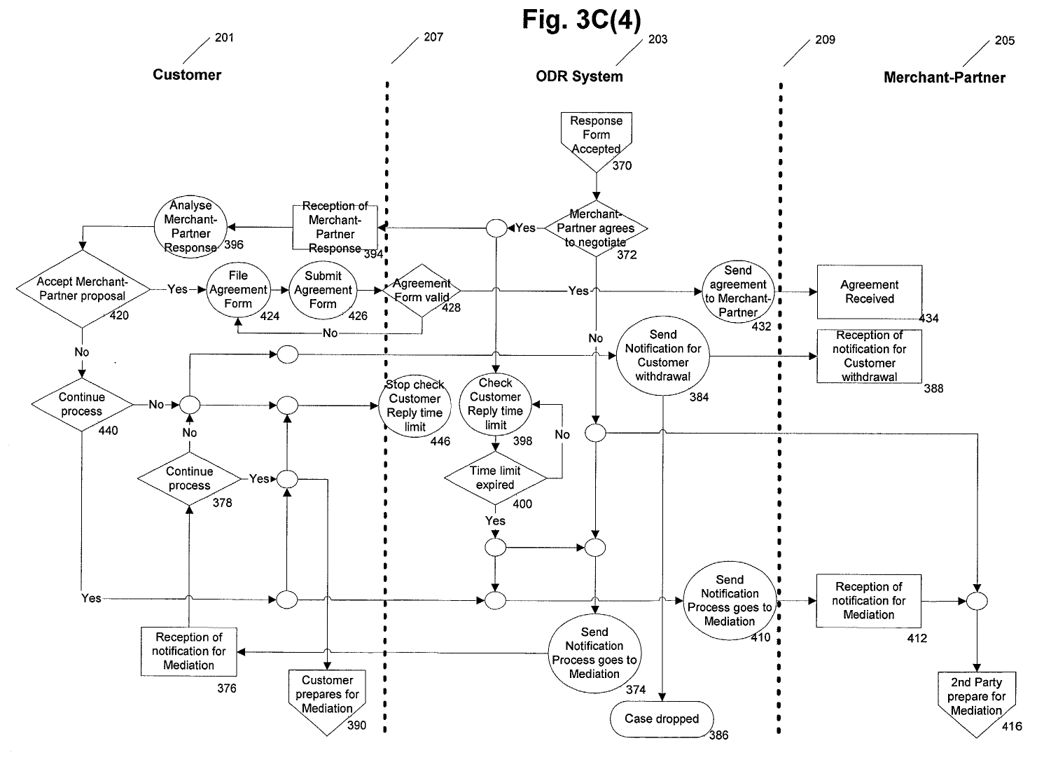

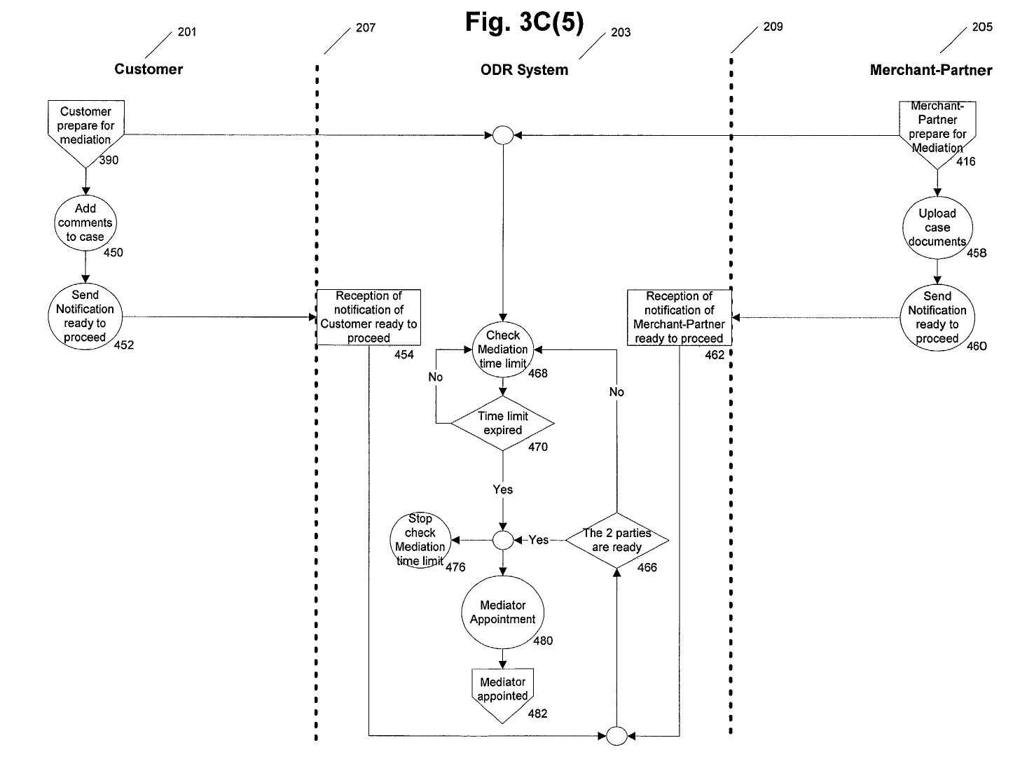

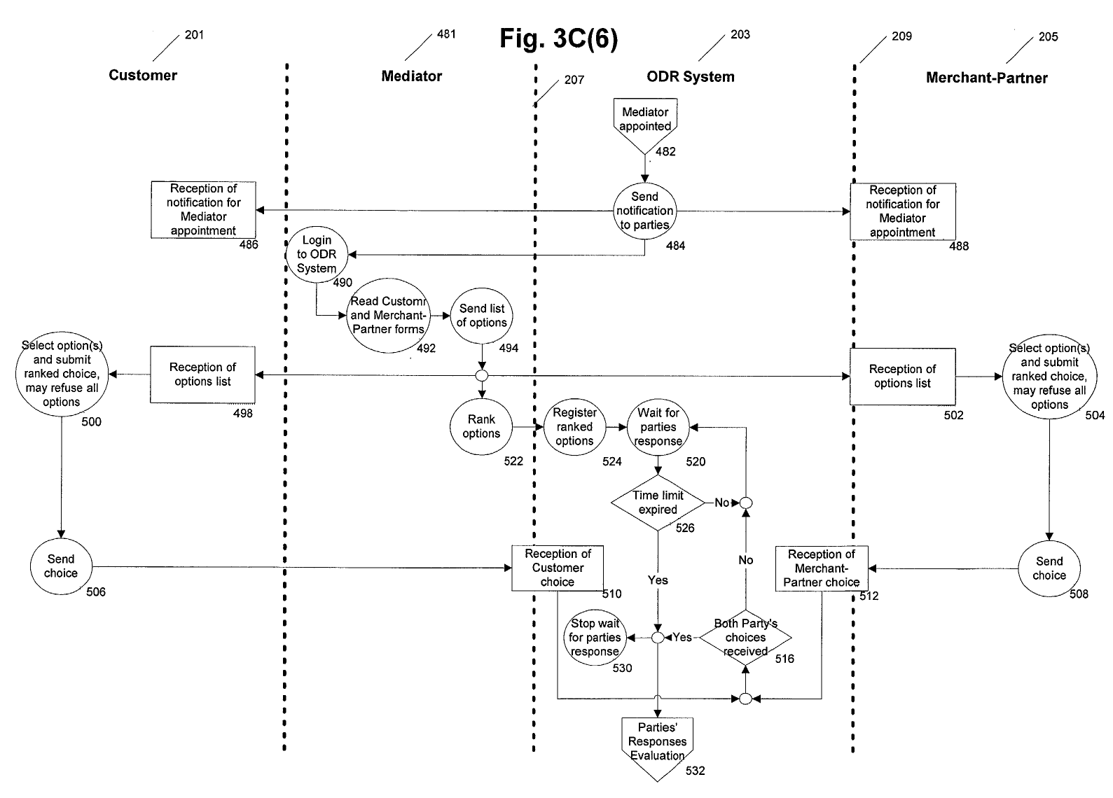

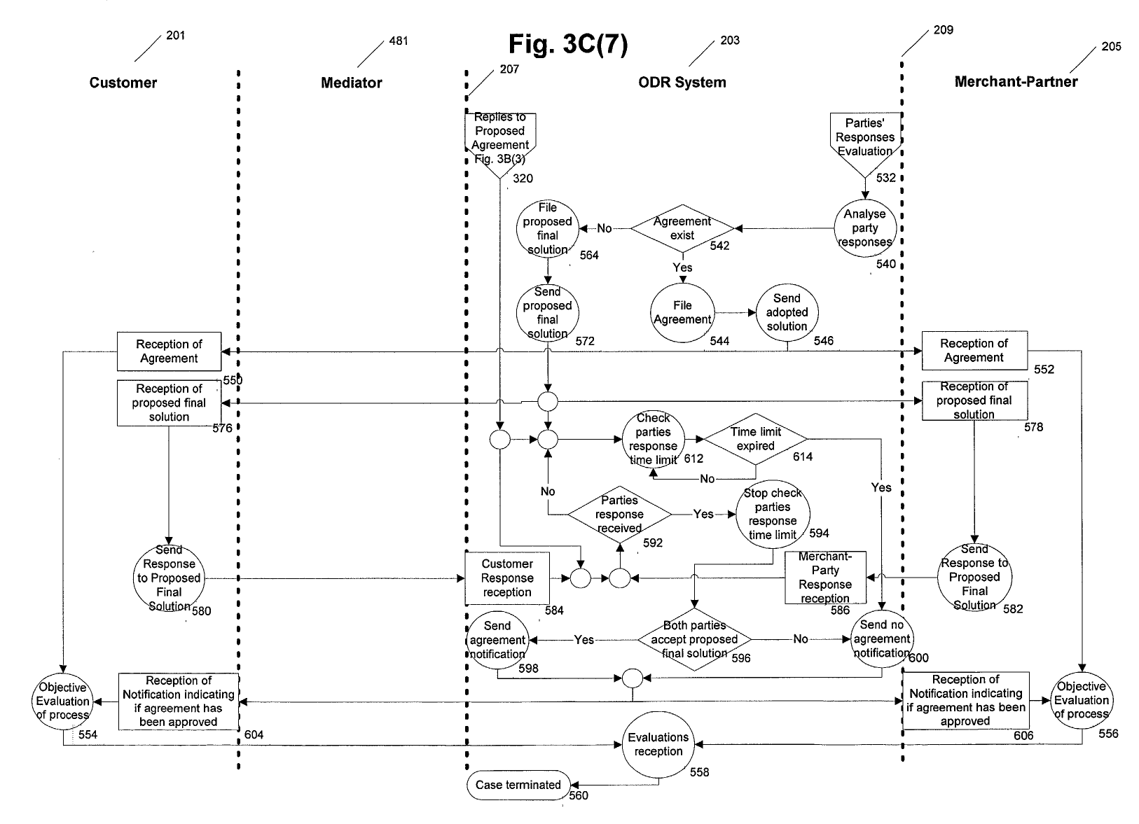

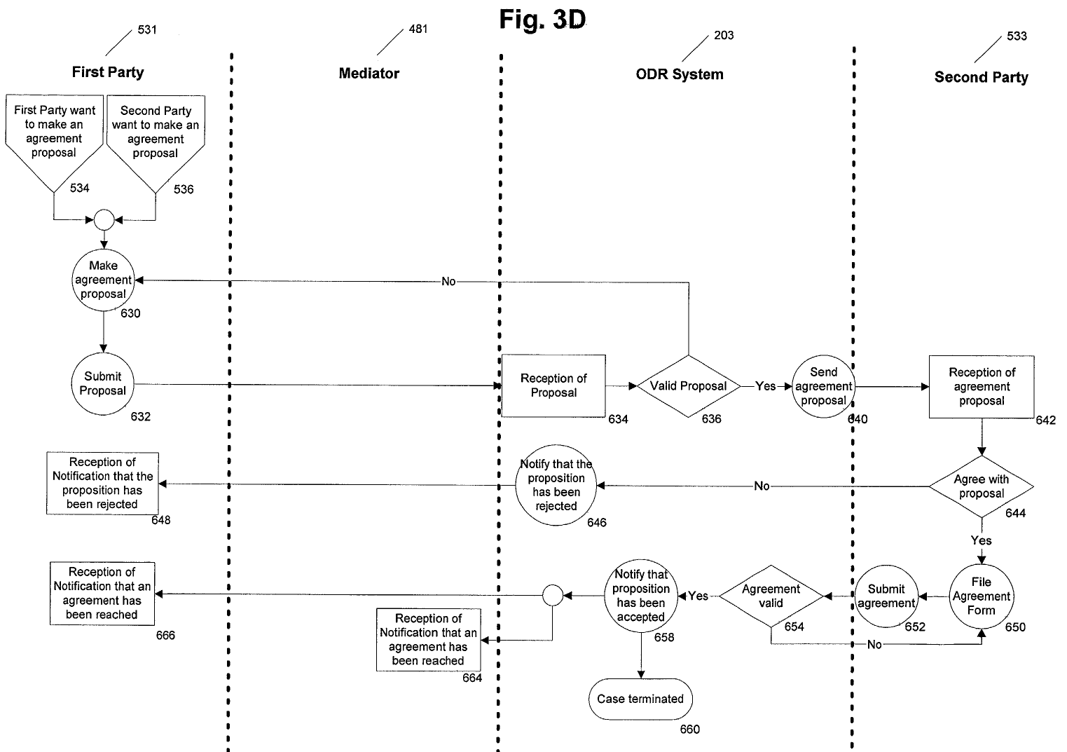

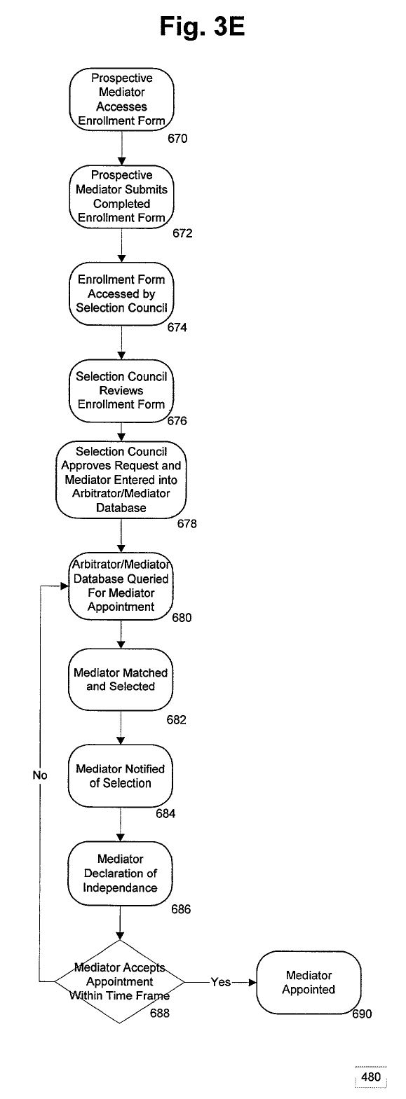

FIG. 3A is a high-level flow diagram illustrating the logic sequence of the NEGO-MED-ARB System, according to some embodiments of the present invention. The NEGO-MED-ARB System provides the parties to a dispute with a structured dispute resolution process that integrates services provided by four dispute resolution systems: the Negotiation System 145, the Mediation System 147, the Arbitration System 149, and the Parallel Negotiation System 151. In operation, the ODR System Program progresses the parties through the system services in the following order: the Negotiation System 145, the Mediation System 147, and, lastly, the Arbitration System 149. In addition to the Negotiation System 145, Mediation System 147, and Arbitration System 149 services, the parties may additionally at anytime in the dispute resolution process use the Parallel Negotiation System 151 to resolve the dispute. The ODR System Program automatically progresses the parties through the integrated dispute resolution process until an agreement is reached or the process is otherwise terminated by the ODR System Program. The ODR System Program may terminate the process prior to reaching an agreement if a party elects to withdraw or, in some circumstances, fails to respond to a system requirement within a specified period. In some embodiments, the merchant-partner is not permitted to withdraw without violating an agreement with the ODR System owner to accept a solution provided by the ODR System. In some embodiments, the ODR System Program executes the ODR events of the NEGO-MED-ARB System services within a pre-determined, expedited and structured time-frame.

In some embodiments, the NEGO-MED-ARB System employs a merchant-partner program. In the merchant-partner program, merchants with an Internet business Web site (including merchants that do not engage in e-commerce) contract with the ODR System owner to make the NEGO-MED-ARB System services available to its customers in dispute with the merchant. In some embodiments, the merchant by agreement with the ODR System owner decides the cost to its customers for using the NEGO-MED-ARB System. In some embodiments, a customer cost sufficiently high to deter frivolous disputes may be desirable. In the merchant-partner program, the merchant-partner is also provided authorization to use a trust mark on its Web site to enables customers to hyperlink efficiently to the NEGO-MED-ARB System. These processes are discussed in detail below.

2. Merchant Enrollment Process

FIG. 3B is a flow diagram illustrating the merchant enrollment process 108 used in the NEGO-MED-ARB System, according to some embodiments of the invention. In stage 182, an e-commerce merchant accesses the ODR System Web site via a Web browser operating on a client computer connected to the Web. In stage 184, the merchant reviews information provided on the ODR System website (e.g., a Partner-Merchant Notice Page) to assist it in deciding whether to enroll in the NEGO-MED-ARB System 142. This information includes the rules and procedures to be followed during the Dispute Resolution Process, and the terms and conditions for using the ODR Trust Mark (explained below). In some embodiments, enrollment is generally conditioned on the merchant's agreement to the aforementioned rules, procedures, terms and conditions. In stage 186, the merchant electronically executes an agreement with the ODR System to follow the rules, procedures, terms and conditions of the NEGO-MED-ARB System. The merchant also provides information regarding his or her identity, means of contact, and payment of fees. In some embodiments, the merchant pays two fees: a flat fee for use of the ODR Trust Mark for a specific time period, and a fee for each dispute in which ODR services are used. In some embodiments, the merchant fees may include amounts normally charged to the consumer; in these embodiments, the merchant effectively subsidizes the consumer's use of ODR services (the consumer's use is free of cost), which may facilitate the use and growth of the ODR System as well as consumer confidence in the e-merchant's goods and services. After payment of fees, the merchant is enrolled as a merchant-partner. In stage 188, the ODR System Program creates a user account for the merchant-partner. The ODR System Program provides the merchant-partner with unique access-keys enabling the merchant-partner to access a private Web space (accessible only by the merchant-partner) on the System Web site (hereafter, “merchant-partner Web space”); in some embodiments, the access-keys are a unique username and password. In some embodiments, the ODR System Program centralizes all dispute related information for a particular merchant-partner in the merchant-partner Web space; this may include tracking, update and status information on the pending cases, as well as closed and archived cases. In stage 190, the merchant-partner is presented a login Web page which requests its access-key; the merchant-partner provides the access-key and enters the merchant-partner Web space. The majority of the merchant-partner's interaction with the NEGO-MED-ARB System 142 is conducted using hyperlinks embedding executable commands located in the merchant-partner's Web space.

In stage 192, a merchant-partner is authorized to use a Trust Mark on his or her e-commerce Web site. In some embodiments, the Trust Mark is a distinctive, stylized icon or text that may be readily associated by consumers to the ODR System; it may, for example, be a registered service mark (federal or state). The Trust Mark has a unique identification number assigned to it for each merchant-partner, and includes an invisible watermark. The identification number and watermark are used to exercise control over how the Trust Mark is used, and to identify the merchant Web site when the Trust Mark is used by the customer to link to the ODR Web site. The Trust Mark is generally displayed in a similar manner on e-commerce Web sites according to uniform rules promulgated and maintained, in some embodiments, by the owner of the ODR System. The Trust Mark enables a party browsing the merchant-partner's e-commerce Web site to access ODR services on the ODR System Web site; in some embodiments, the Trust Mark operates as a hyperlink to dispute resolution services on the ODR System Web site, thus enabling one-click access to ODR services from an merchant-partner e-commerce Web site. When a customer hyperlinks to the ODR System Web site, the merchant-partner's unique identification number is sent to ODR System Program; this enables the ODR System Program to automatically determine which merchant-partner is involved in a dispute with customer. In stage 194, a properly authorized merchant-partner displays the Trust Mark on its e-commerce Web site. In addition to providing one-click access to ODR services, the Trust Mark also enables e-commerce merchants to advertise valuable ODR services to consumers and businesses browsing the e-commerce Web site, thus developing confidence in engaging in e-commerce transactions at the Web site.

3. NEGO-MED-ARB Processes

FIG. 3C, comprising FIGS. 3C(1) to 3C(7), is a flow diagram illustrating process flow in the NEGO-MED-ARB System, according to some embodiments of the invention. In particular, FIGS. 3C(1) to 3C(4) illustrates process flow in Negotiation System 145; FIGS. 3C(5) to 3C(6), and some stages in FIG. 3C(7), illustrate process flow in Mediation System 147. Lastly, FIG. 3C(7) (excluding certain stages occurring in the Mediation System 147) illustrate process flow for the Arbitration System 149.

Referring to FIG. 3C(1), the flow diagram has three vertical columns 201, 203, and 205, separated by vertical dotted-line dividers 207 and 209. The first column 201 represents events performed by the purchasing customer in a commercial transaction with a merchant-partner, typically a consumer or business. The second column represents events performed by the ODR System controlled by the ODR System Program. Lastly, the third column 205 represents events performed by the seller to the transaction, typically the merchant-partner. FIGS. 3C(2) to 3C(5) share the same column layout as FIG. 3C1. Turning to FIG. 3C(1), in stage 200 of the illustrative process, the customer initiates NEGO-MED-ARB System services with a merchant-partner by accessing the merchant-partner's e-commerce Web site displaying the ODR Trust Mark. In stage 202, the customer clicks on the Trust Mark, and hyperlinks to a dispute resolution start page on the System Web site. The customer may also access the ODR Web site directly in which case he would be asked to identify the merchant-partner to the dispute from a list provided by the ODR System Program. In stage 204, the start page provides the customer with overview information about the NEGO-MED-ARB System 142, including the rules governing its use. In stage 206, the customer decides whether to execute an electronic agreement with the ODR System formalizing the customer's agreement to comply with the aforementioned rules; this is generally a prerequisite to initiating an ODR services against the merchant-partner. In stage 208, the customer decides to execute the electronic agreement, and is sent a registration page by the ODR System Program; the customer enters information as requested by the registration page, such as the customer's identity and preferred manner of contact by the ODR System (e.g., contact by email, fax, pager, mobile phone, traditional post). If the customer decides not to execute the electronic agreement, the process is terminated in stage 244.

In stage 210, the ODR System Program checks the registration information submitted by the customer from a database to determine whether the customer had previously registered in the ODR System. In stage 224, if the customer is previously registered, the ODR System Program adds a new open case to the customer's account data; otherwise, in stage 212, the ODR System Program creates a new user account and, in stage 214, sends an email notification to the customer to confirm the customer's identity prior to activation of the customer's account. In stage 216, the customer receives the email notification, and replies to the notification with an email acknowledgment. In stage 218, the ODR System Program receives the customer acknowledgement and activates the customer account, and in stage 224, creates a new open case in the customer account. In stage 238, the ODR System Program assigns the customer a unique access-key, such as a username and password, which the customer uses to login to the ODR System. In stage 226, after the ODR System creates a new dispute resolution case, it assigns a time limit for the customer to complete an online Application Form (explained below). In stage 228, the ODR System Program periodically checks to determine whether the customer has completed and submitted the Application Form to the ODR System within the time limit. If the Application Form is not submitted to the ODR System within the time limit, then in stage 232, the ODR System Program sends to the customer an official notification of case dismissal by email. In stage 234, the customer receives the email notification dismissing the case, and in stage 236, the case is dismissed.

Turning now to FIG. 3C(2)—which continues the flow diagram of FIG. 3(1)—in stage 248, the ODR System Program determines whether the customer accessed the ODR System Web site via a Trust Mark hyperlink located on a merchant-partner e-commerce Web site. If the customer did not hyperlink from a Trust Mark, then, in stage 250, the customer is required to select the merchant-partner to the dispute from a list provided by the ODR System Program. In stage 252, after the ODR System Program determines the merchant-partner to the dispute, an Application Form is presented to the customer. In some embodiments, the Application Form may require the customer to provide several items of data, including, for example: the identity of an agent (such as legal counsel) acting on behalf of the customer; information relating to the product line or services from which the dispute arises; facts related to the dispute; a list containing up to three solutions acceptable to the customer (hereafter, “customer proposed solutions”), whether proposed by the customer or selected by the customer from a predetermined list provided by the ODR System Program (in some embodiments, the customer must specify at least one option for the ODR System Program to accept the Application Form); an explanation of the basis for the customer proposed solutions (this information is accessible only by a duly-appointed mediator); and, in some embodiments, customer payment information (e.g., credit card information). It should be noted that in some embodiments no payment information will be required of the customer because the customer's fees were integrated into the merchant-partner's fee. In some embodiments, the customer may be required to pay a small fee. In some embodiments, the customer fee structure is determined by agreement between the ODR system owner and the merchant-partner.

In stage 254, the customer uploads or faxes all pertinent documents that the party believes is relevant to makes its case when submitting the Application Form to the ODR System Program. In some embodiments, where payment by the customer is required, process flow moves to stage 259, where the ODR System Program performs the payment transaction (typically by automated processing of customer's credit card or other e-payment means). In stage 250, payment is completed and verified. In stage 256, the customer sends the completed Application Form to the ODR System Program. In stage 252, the ODR System Program validates the Application. In stage 256, the ODR System Program determines whether the Application Form was validly completed, and whether payment was successfully made. If either of these was not performed properly, then, in stage 276, the ODR System Program sends an email official notification to the customer that all system requirements must be performed to pursue ODR services, namely, proper completion of the Application Form and, in some embodiments, payment of fees; process then resumes in stage 252. If the ODR System Program determines that the Application Form is valid and that receipt of payment (in some embodiments) is verified, then in stage 272, the ODR System Program terminates the process of determining whether submission of the Application Form has exceeded the filing time limit as initiated in stage 226, in stage 270, the ODR System Program accepts the Application in stage 270.

Turning now to FIG. 3C(3)—which continues the flow diagram of FIG. 3C(2)—in stage 280, the ODR System Program sends a new case email notification to the parties indicating that it has opened a new case and initiated ODR services to resolve their dispute; the ODR System Program also sets a response time limit for the merchant-partner to submit a response to the customer Application Form. In some embodiments, the response time limit requires the merchant-partner to respond expeditiously, for example, within a few days. In stage 282, the customer receives the new case email notification and then waits to receive the response from the merchant-partner within the response time limit. In stage 284, the merchant-partner receives the new case email notification which includes a system-generated case identifier; the case identifier is used by the merchant-partner to access selected information submitted by the customer on the Application Form. In stage 304, the ODR System Program initiated a process to check at periodic time intervals whether the merchant-partner has responded within the response time limit. In stage 306, the ODR System Program determines whether the merchant-partner has responded within the response time limit. If the merchant-partner has not timely responded, then in stage 308 the ODR System Program presumes that the merchant-partner has accepted the first solution in the list of customer proposed solutions. The ODR System Program then formalizes the presumption—that the merchant-partner has agreed to the first customer proposed solution—by creating an Agreement Form which is sent to the parties for their approval. In some embodiments, the customer is never bound by the ODR processes; in some embodiments, the merchant-partner may agree in advance to be bound to any ODR outcome. In some embodiments, both parties must explicitly approve the Agreement Form generated by the ODR System Program before the Agreement Form becomes binding on the parties. In stage 312, the ODR System Program sends the Agreement Form to the customer, and in stage 316, the customer receives it. In stage 314, the ODR System Program sends the Agreement Form to the merchant-partner, and in stage 318, the merchant-partner receives it.

In stage 286, the merchant-partner connects to the System Web site and enters its merchant-partner Web space using its access-keys obtained during merchant-partner enrollment. In stage 288, the merchant-partner sends the case identifier to the ODR System Program and is given access to selected portions of the Application information, including the customer proposed solutions. Generally, however, the explanations provided by the customer in support of the customer proposed solutions and other information (such as the customer's credit card information) are not accessible by the merchant-partner. In stage 290, the merchant-partner decides whether or not to accept one of the customer proposed solutions.

If in stage 290 the merchant-partner accepts one of the customer proposed solutions, then in stage 296 the merchant-partner sends an Agreement Form to the ODR System indicating its agreement to the particular customer proposed solution. In stage 300, the ODR System Program checks the validity of the Agreement Form. If the Proposed Agreement Form omits requisite information and does not meet a minimum level of validity, then a notification is sent to the merchant-partner to provide a valid Agreement Form, in which case process is returned to stage 296. If the Agreement Form is validated by the ODR System Program, then in stage 360, the Agreement Form is sent to the customer. The Agreement Form is received by the customer in stage 362, and after approval by the customer of the proposed agreement, the case is terminated in stage 364. If in stage 290 the merchant-partner does not agree to any of the customer proposed solutions, the merchant-partner then decides whether to request dismissal of the case (dismissal may be granted at this stage because, for example, a settlement may have already been reached and confirmed by the customer, or the case was brought for an improper or bad faith purpose, such as to harass the merchant-partner). In stage 330, the ODR System Program determines whether to accept the dismissal request; in some embodiments, this decision is performed by the ODR System Clerk. In stage 332, if the ODR System Program accepts the dismissal request, a notice of dismissal is sent to the customer in stage 334, and to the merchant-partner in stage 336. In stage 338, after the ODR System Program sends the notice of dismissal to the parties, the case is officially dismissed. If in stage 330 the ODR System Program does not accept the merchant-partner request for dismissal, then in stage 340 it sends a notice to the merchant-partner rejecting the dismissal request and indicating that completion of a Response Form must be submitted; this notice is received by the merchant-partner in stage 342. In stage 346, the merchant-partner completes the Response Form accessible via the merchant-partner Web space. In the Response Form, the merchant-partner responds to the customer allegations and proposed solutions provided in the customer Application Form; the merchant-partner also provides any additional information required by the ODR process. In some embodiments, the Response Form is similar to the Application Form (with the exception that payment information is typically absent from the Response Form). The merchant-partner may then upload any documents the merchant-partner believes is pertinent to the dispute, or may wait to upload such documents until a later date if the case goes to mediation (stage 458). In some embodiments, the Response Form is completed and submitted within an expeditious time period, preferably seven days. In stage 350, the ODR System Program validates the Response Form. In stage 352, if the Response Form was successfully validated, the ODR System Program accepts the Response Form in stage 370 and terminates the process of determining whether the merchant-partner has timely submitted its response. If the Response Form is not successfully validated in stage 352, then process is returned to stage 346 where the merchant-partner is instructed of its requirement to submit a validated Response Form.

Turning now to FIG. 3C(4)—which continues the flow diagram of FIG. 3C(3)—after the ODR System Program accepts the merchant-partner's Response Form, then in stage 372 it determines from the Response Form whether the merchant-partner has agreed to participate in a negotiation process. If the merchant-partner has indicated its desire to bypass the negotiation process and proceed directly to mediation, the ODR System Program in stage 374 sends an email notice to the customer that the case is going to mediation, which notice the customer receives in stage 376. In stage 378, the customer may then decide to withdraw from the ODR processes if the customer decides to withdraw, then in stage 384 the ODR System Program sends an email notice to the merchant-partner that the customer has withdrawn; which the merchant-partner receives in stage 388. In stage 386, the ODR System Program drops the case. If in stage 378 the customer decides to proceed to mediation, then the customer prepares for mediation in stage 390. If in stage 372 the merchant-partner decides not to go directly to mediation but instead has decided to enter negotiations with the customer, then in stage 394 the ODR System Program sends an email notice to the customer that the Response Form was submitted by the merchant-partner. The customer may now access and view selected information from the Response Form including the merchant-partner's response to the customer proposed solutions and description of the dispute. In addition, in stage 398, the ODR System Program sets a reply time limit for the customer to submit a Reply Form in response to the merchant-partner's Response Form. In stage 398, the ODR System Program periodically checks whether the reply time limit is exceeded by the customer. In stage 400, if the ODR System Program determines that the reply time limit has expired before the consumer submitted the Reply Form, then the ODR System Program sends an email notice to the parties that the dispute is entering mediation. In stage 410, the ODR System Program sends the email notice to the merchant-partner, and in stage 412, the merchant-partner receives it. In stage 416, the merchant-partner prepares for mediation. In stage 374, the ODR System Program sends an email mediation notice to the customer, and process resumes in stage 376 as described above.

Returning to stage 394, the customer receives an email notice that the merchant-partner's response information is accessible to the customer at the ODR System Web site. In stage 420, the customer analyzes the response information and merchant-partner proposed solutions, and decides whether to accept one of the merchant-partner proposed solutions. In stage 420, if the customer accepts one of the merchant-partner solutions, then in stage 424 the customer submits an Agreement Form to the ODR System Program. In stage 428, the ODR System Program validates the Agreement Form 428; if the Agreement Form is not validly completed by the customer, then process returns to stage 424 and the ODR System Program informs the customer that only a validly completed Agreement Form may be submitted. In stage 432, if the Agreement Form is valid, then the ODR System Program sends the Agreement Form to the merchant-partner. The merchant-partner receives the Agreement Form in stage 434. Returning to stage 420, if the customer does not agree with any of the merchant-partner proposed solutions, then in stage 440, the customer decides whether to withdraw from the ODR System. If the customer decides to withdraw from the ODR System, then process resumes in stages 384 and 446 as described above. If the customer decides to proceed with mediation, then process resumes in stages 410 and 390 as described above.

Turning now to FIG. 3C(5)—which continues the flow diagram of FIG. 3C(4)—the parties have prepared for mediation in stages 390 and 416, and the ODR System Program then proceeds to assign a mediator to the dispute. In stage 468, the ODR System Program initially fixes a supplemental information time limit for the parties to submit additional information to supplement the dispute record (the dispute record at this point in the ODR process generally comprises the information submitted in the customer Application Form, the merchant-partner Response Form, and the customer Reply Form). In stage 470, if the supplemental information time limit expires prior to either party supplementing the record with additional information, the ODR System Program nevertheless proceeds in stage 480 to appoint a mediator. Prior to expiration of the supplemental information time limit, the customer in stage 450 may supplement the dispute record with, for example, additional information about the dispute, commentary on allegations made by the merchant-partner in its response, and any proposed solutions. In stage 458, the merchant-partner may also supplement the dispute record, for example, by uploading documents that it deems relevant which it did not do when filing the Response Form. In stages 452 and 460, the customer and merchant-partner send email notifications to the ODR System Program that supplementary information has been submitted, and that each party is ready to proceed with mediation; these email notifications are received by the ODR System Program in stages 454 and 462.

In stage 466, the ODR System Program determines whether the parties are ready to proceed with mediation. If the ODR System Program determines that the parties are ready to proceed, then in stage 461, the ODR System Program ceases to check whether the supplemental information time limit has expired, and proceeds to appoint a mediator in stage 480. If the ODR System Program determines that the parties are not ready to proceed with mediation, then it continues to wait for a further email notification by the parties of their readiness to proceed, prior to the supplemental information time limit expiring. In stage 480, the ODR System Program appoints a mediator to the case; the process by which a mediator is appointed is described in the Mediator Appointment Process section below in reference to FIG. 3E. In addition, it should be understood that during the entire ODR process described herein, a parallel negotiation process may be initiated between the parties; this negotiation process is described in detail in the next section entitled Parallel Negotiation Process in reference to FIG. 3D.

Turning now to FIG. 3C(6)—which continues the flow diagram of FIG. 3C(5)—in stage 482, the ODR System Program appoints the mediator, and in stage 484, sends an email notice to the customer and the merchant-partner of the appointed mediator; the email notification is received by the customer in stage 486 and by the merchant-partner in stage 488. It should be noted that FIG. 3C(6) includes an additional vertical column 481, positioned between vertical column 201 and vertical column 203; vertical column 481 represents stages where actions are performed by the mediator in the NEGO-MED-ARB Systems. FIG. 3C(7) uses the same column layout as FIG. 3C(6). Turning to FIG. 3C(6), in stage 490, the appointed mediator logs into the ODR System to access the case information through its private mediator Web space maintained by the ODR System Program at the ODR System Web site. The mediator has access to all information provided by the parties to which the parties have given the mediator access rights. In stage 492, the mediator reviews the case information. In stage 494, the mediator prepares a list of mediator proposed solutions based on the entire record of the dispute, including the parties' proposed solutions and commentaries. In stage 522, the mediator ranks the mediator proposed solutions in light of equitable principles. In stage 524, the mediator registers the ranked mediator proposed solutions with the ODR System Program, which then stores the ranked solutions in the ODR System. The ranked solutions are not accessible to the parties and are intended for use by the ODR System Program only after it has received the parties' replies to the mediator proposed solutions. After the mediator has constructed the list of proposed mediator solutions, it sends an email notification to the parties of the accessibility of the unranked list of mediator proposed solutions on the ODR System Web site. In stage 498 the customer receives the email notification; and in stage 502, the merchant-partner receives the email notification. In stages 520 and 526, the ODR System Program assigns a mediator solution response time limit for the parties to respond to the proposed mediator solutions. If this time limit expires prior to response by the parties, then the ODR System Program automatically advances the ODR process to stage 532. In stage 500, the customer reviews the mediator proposed solutions, and then either ranks the proposed solutions in order of acceptability, or refuses all the proposals; in stage 504, the merchant-partner independently performs the same analysis and ranking of the mediator proposed solutions. In stage 506, the customer submits its response to the proposed mediator solutions to the ODR System Program; the response is received by the ODR System Program in stages 510. In stage 504, the merchant-partner submits its response to the mediator proposed solutions to the ODR System Program; the response is received by the ODR System Program in stages 512. In stage 516, the ODR System Program determines whether responses to the mediator proposed solutions were received from both parties. If both parties' responses were received, then in stage 530, the ODR System Program ceases to check whether the mediator solution response time limit has expired, and proceeds to evaluate the parties' responses in stage 532; otherwise, process moves to stage 520 as described above.

Turning now to FIG. 3C(7)—which continues the flow diagram of FIG. 3C(6)—in stage 540, the ODR System Program analyzes the mediator proposed solutions selected by the parties. In stage 542, the ODR System Program determines whether the parties have selected a common solution proposed by the mediator. In some embodiments, the parties may rank the mediator proposed solutions on the basis of acceptability. In other embodiments, the parties may assign a percentage to each mediator proposed solution representing a percentage satisfaction by the party to the particular proposed solution. Other embodiments may employ various different methods and algorithms for determining when a common or acceptable solution is indicated by the parties. If the parties indicate at least one common solution, then the ODR System Program automatically resolves the dispute on that basis in stages 544 and 546. In stage 544, the ODR System Program creates an Agreement Form formalizing the agreement to the parties, which it then sends by email to the parties in stage 546. The customer receives the Agreement Form by email in stage 558, and then completes an objective evaluation of the ODR process in stage 554. The merchant-partner receives the Agreement Form in stage 552, and then independently completes an objective evaluation of the ODR process in stage 556. In stage 558, the ODR System Program receives the objective evaluations from the parties, and stores them for later analysis. The ODR System Program then terminates the case proceeding in stage 560.

If in stage 542 the ODR System Program determines that the parties did not select a common mediator proposed solution, then in stage 564 an arbitration process is initiated to produce a proposed final solution to resolve the case; in some embodiments, the proposed final solution will operate as an arbitration award. In some embodiments, the parties may have entered a prior agreement to be bound by the proposed final solution. In other embodiments, the merchant-partner may have entered a prior agreement with the ODR System owner to be unilaterally bound by the proposed final solution. In some embodiments, the proposed final solution is produced automatically by the ODR System Program based on the information accrued in the negotiation and mediation phases. In some embodiments, the automated process may be performed using an intelligent agent to examine the parties' responses to the mediator proposed solutions. The agent may use the ranked solution options provided by the mediator and the parties to compile a score for each proposed solution, which then enables the solutions to be ranked on the basis of their scores. The agent may then generate a proposed final solution for the parties based on the solutions having the best score. In some embodiments, the ODR System Program notifies the mediator to access the parties' responses to the mediator proposed solutions on the ODR System. After examining the record of information accrued by the ODR System in the case, including the parties' responses to the mediator proposed solutions, the mediator then produces a proposed final solution based on the equitable and legal principles governing the case. In some embodiments, where the mediator is required to produce a proposed final solution, the mediator will also be a qualified arbitrator.

In stage 572, the ODR System Program sends the proposed final solution to the parties, which is received by the customer in stage 576 and by the merchant-partner in stage 578. In stages 612 and 614, the ODR System Program also initiates a process of checking a time-limit for the parties to respond to the proposed final solution. If in stage 614 the ODR System Program determines that the time-limit expired before both parties respond, then it sends in stage 600 an email notification to the parties that the proposed final solution was not agreed upon to resolve the dispute; this email notification is received by the customer in stage 604 and the merchant-partner in stage 606. The customer and merchant-partner then complete objective evaluations of the ODR process, and the case is terminated in stages 554, 556 and 560, as described above. If in the time-limit has not expired in stage 614, then the customer in stage 580 and the merchant-partner in stage 582 send their decision as to acceptance of the proposed final solution to the ODR System Program. The ODR System Program receives the parties' decisions in stages 584 and 586, and in stages 592 and 594 ceases the time-limit checking process. After the ODR System Program determines that both parties' responses are received in stage 592, then in stage 596, the ODR System Program determinates whether both parties have approved the proposed final solution. If both parties have approved the proposed final solution, then in stage 598 the ODR System Program sends an email notice to the parties that the proposed final solution has been agreed to by the parties and has become a binding settlement for the parties. Otherwise, in stage 600 the ODR System Program sends a notice to the parties that the proposed final solution was rejected, and that the case will be closed without a solution. In both circumstances, the process resumes in stages 604 and 606 as described above (i.e., the parties make objective evaluations of the NEGO-MED-ARB System, and the case is terminated). In some embodiments, the merchant-partner may be contractually bound to the ODR System owner to accept the proposed final solution; therefore, rejection of the proposed final solution by the merchant-partner may result in a contractual breach by the merchant-partner. In some embodiments, the customer and the merchant-partner may have made a prior agreement to accept the proposed final solution in the event that they parties were unable to conclude an agreement between themselves.

4. Parallel Negotiation Process

FIG. 3D is a flow diagram illustrating the basic steps of the parallel negotiation process, according to some embodiments of the invention. The parallel negotiation process may be initiated by either party—the customer or the merchant-partner—at any time during the NEGO-MED-ARB System process described in FIGS. 3C(1)-3C(7). Unlike FIG. 3C, however, vertical column 531 in FIG. 3D represents actions performed by the party initiating the parallel negotiation process (hereafter “First Party”), which may be either the customer or the merchant-partner. Analogously, vertical column 533 represents actions performed by the non-initiating party (hereafter the “Second Party”) which may again be either the customer or the merchant-partner.

Turning to FIG. 3D, in stages 534 and 630, First Party makes a negotiation agreement proposal, which it then submits to the ODR System Program in stage 632. In stage 634, the ODR System Program receives the negotiation agreement proposal, which it then proceeds to validate in stage 636. If the negotiation agreement proposal is determined valid, then the ODR System Program in stage 640 sends the proposal to the Second Party for evaluation. In stage 642, the Second Party receives the proposal and, in stage 644, analyzes it for acceptability. If the Second Party does not agree with the proposal, then in stage 646 the Second Party notifies the ODR System Program that it does not accept the proposal. The ODR System Program then forwards a notice of the rejection to the First Party in stage 648. If, however, the Second Party accepts the negotiation agreement proposal in stage 644, then the Second Party in stage 650 completes an Agreement Form based on the proposal. In stage 652, the Second Party submits the Agreement Form to the ODR System Program, which then determines the validity of the Agreement Form in stage 654. If the Agreement Form is not validly completed, then the ODR System Program notifies the Second Party of its invalidity, and instructs the Second Party to properly complete the Agreement Form for proper submission; process then returns to stage 650, where stages 650, 652 and 654 are repeated until a proper Agreement Form is submitted by the Second Party. After the Agreement Form is validly submitted by the Second Party, the ODR System Program notifies the First Party and the mediator (if one has already been appointed in the case) that the case is resolved on the basis of the negotiation agreement proposal; the First Party receives this notification in stage 666, and the mediator receives this notification in stage 664. In stage 660, the ODR System Program terminates any ODR processes and closes the case.

5. Mediator Appointment Process

FIG. 3E is a flow diagram illustrating the stages of the mediator appointment process for the NEGO-MED-ARB System, according to some embodiments of the invention. In stage 670, a prospective mediator accesses the ODR System Web site and is linked to an online Enrollment Form. In stage 672, the prospective mediator provides the information to complete the Enrollment Form; the requisite information may include the mediator's field of expertise, geographic location, and language proficiency. In stage 674, the ODR System Program stores the information provided on the Enrollment Form for later analysis by a group of senior mediators and arbitrators (hereafter, the “Selection Council”) responsible for selecting new mediators. In stage 676, the Selection Council reviews the Enrollment Form information to determine whether the applicant qualifies as a suitable mediator. Typically a suitable mediator is one with a proven track record as a specialist in certain categories of disputes, with appropriate training and certifications. In stage 678, the mediators approved as suitable by the Selection Council are added to a mediator database maintained by the ODR System Program.

Stages 680 to 690 represent a series of stages in the mediator appointment process representing sub-stages in stage 480 of the NEGO-MED-ARB System as described in reference to FIG. 3C(5). In stage 680, the ODR System Program queries the mediator database for a suitable mediator based on certain pre-established criteria including the mediator's language, location, and field of expertise. The ODR System Program then automatically detects a suitable mediator by matching the criteria in the mediator database with information supplied by the parties during the NEGO-MED-ARB System. In stage 682, the ODR System Program selects the mediator after evaluating the mediator's workload; if the mediator's workload renders doubt as to the mediator's ability to conduct the mediation, the ODR System Program selects a different mediator. In stage 684, the ODR System Program sends an email notice to the selected mediator of the mediator's selection; the notice provides information that will enable the mediator to access pertinent information about the dispute from the ODR System Web site. The mediator accesses its private mediator Web space on the ODR System Web site, and analyzes the information relating to the dispute. The mediator then decides whether he or she is competent to perform the mediation (i.e., the mediator is sufficiently independent from the parties and events giving rise to the dispute; if the mediator accepts the appointment, then in stage 690 the ODR System Program appoints the mediator to mediate the case. After the ODR System Program notifies the mediator of its selection to the case in stage 684, the mediator must accept the appointment within a pre-determined time-frame; if the ODR System Program determines in stage 688 that the mediator exceeded the time-frame, then process resumes at stage 680 as described above. Steps 680 through to 688 are repeated until a mediator is appointed to the case.

6. NEGO-MED-ARB Event Time-Frame

In some embodiments, the dispute resolution service events comprising the NEGO-MED-ARB System operate within a pre-determined, expedited time-frame. Table 1 below includes a chronological ordering of certain time-sensitive NEGO-MED-ARB System events (middle column) correlated with the time-period in business days within which the event must occur (third column), according to some embodiments; the events are additionally correlated to the stages in the NEGO-MED-ARB Process as described in FIGS. 3C(1) to 3C(7). Four time-period entries (third column) have an asterisk to indicate stages where the process may be terminated in the event the parties reach agreement.

TABLE 1

| Stage(s) | | |
|---|---|---|
| (FIG. 3C) | Description of NEGO-MED-ARB Event | Time-Period |
| 270 | Customer Application received and accepted | 0 |
| 370 | Merchant-Party Response to Application | 7* |
| | received and accepted | |
| 420 | Customer Reply to Response received and | 10* |
| | accepted | |
| 454-462 | Parties prepare to start mediation | 14 |
| 480 | Mediator appointed | 15 |
| 494 | Mediator sends mediator proposed solutions to | 16 |
| | parties | |
| 510-512 | Parties' response to mediator proposed | 19* |
| | solutions received and accepted | |
| 572 | Mediator sends proposed final solution to | 20 |
| | parties | |
| 592 | Parties' response to proposed final solution | 23* |
| | received and accepted | |
| 598-600 | Proposed final solution notice sent to parties | 24 |

Negotiation/Mediation/Arbitration System

1. Arbitration/Mediation Clause Incorporation Process

In some embodiments, an Arbitration/Mediation Clause (hereafter, “Contact Clause”) is made accessible on the ODR System Web site. The Contact Clause will be available for any party to copy and incorporate in a commercial contract. The Contact Clause provides that the parties to a contract agree to a binding resolution produced by the Negotiation/Mediation/Arbitration System in the event of a dispute arising from the contract. Different versions of the Contact clause (available in different languages) allow the parties to bind themselves to selective ODR processes in the Negotiation/Mediation/Arbitration System; thus, parties may select one or more ODR processes including negotiation, mediation, and voluntary or binding arbitration. The Contact Clause is intended to be enforceable as a matter of commercial contract law; however, enforceability of the Contact Clause in a particular case will depend on the particular facts of the case in view of the commercial law in the relevant jurisdiction.

2. Negotiation/Mediation/Arbitration Services Process

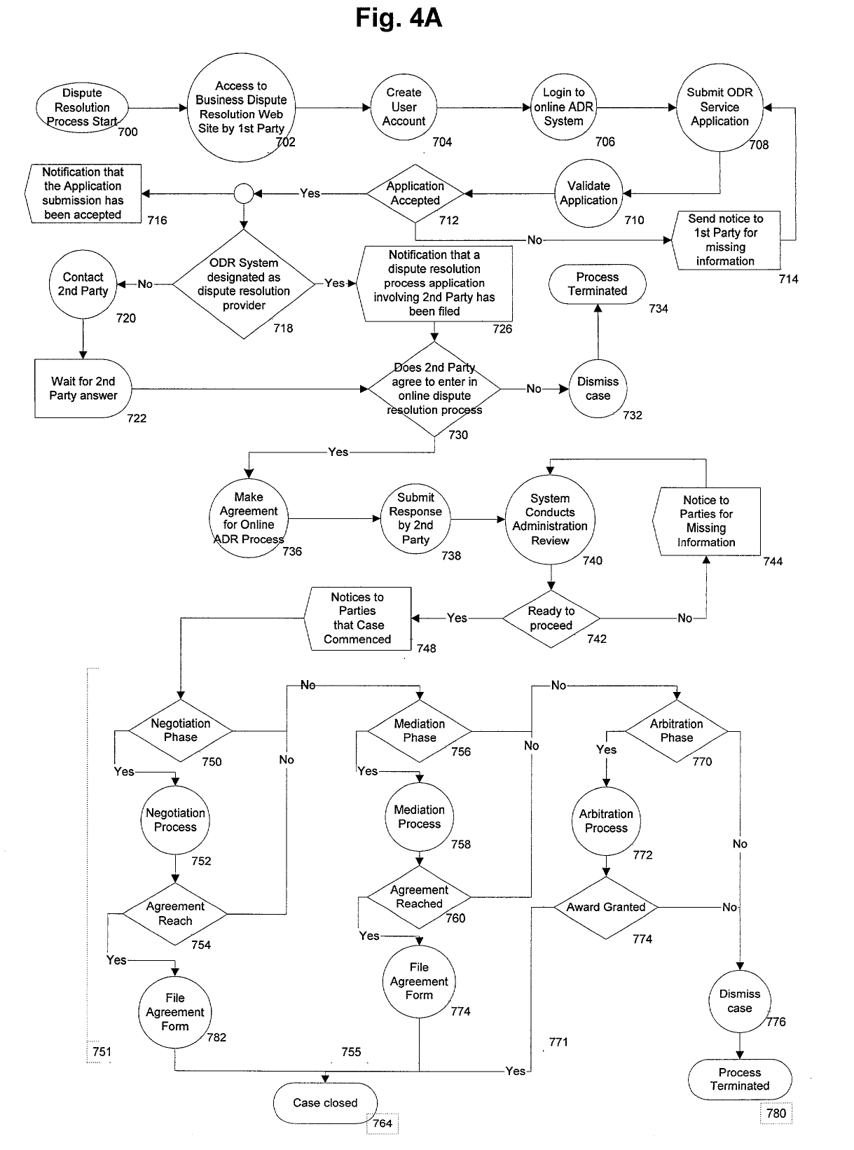

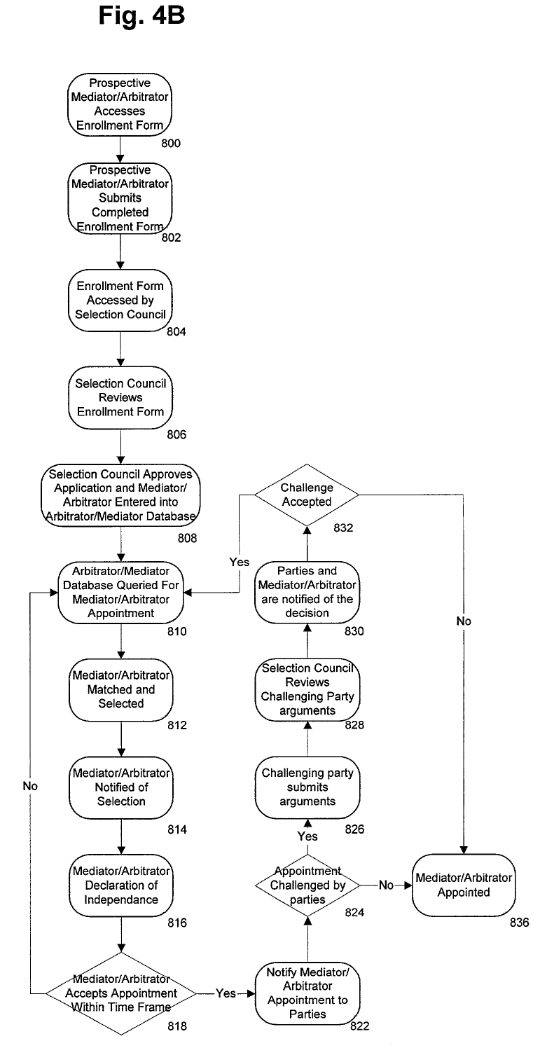

FIG. 4A is a flow diagram illustrating the stages of the process logic of the Negotiation/Mediation/Arbitration System, according to some embodiments. The Negotiation/Meditation/Arbitration Process may be initiated in various ways. In some embodiments, a party may initiate the Negotiation/Meditation/Arbitration Process from the ODR System Web site without having any prior connection to the ODR System. In some embodiments, a party may initiate the Negotiation/Meditation/Arbitration Process via a Trust mark posted at an e-commerce Web site. In these embodiments (as in the NEGO-MED-ARB System), the e-commerce Web site owner typically has made a prior arrangement with the ODR System owner for use of the Trust Mark and the ODR System services.

Turning to FIG. 4A, in stage 700 of the illustrative process, a merchant (hereafter, “First Merchant”), who may be either the buyer or seller, initiates the Negotiation/Meditation/Arbitration processes with another merchant (hereafter, “Second Merchant”) by accessing the ODR System Web site; the parties do not need to be merchant-partners or otherwise previously associated with the ODR System to initiate the Negotiation/Meditation/Arbitration processes. In stage 702, the System Web site provides a hyperlink to one or more Web pages for “Business Disputes” which contains information about how to initiate ODR with another merchant; the information provided at this stage may include an overview of the rules and procedures of the Negotiation/Meditation/Arbitration processes, how to access the ODR System Web site, fees and payment processes, choice of language, and biographical descriptions of the arbitrators and mediators available for resolving disputes. Two further hyperlinks are provided to enable the First Merchant to access the ODR System: one for merchants with existing user accounts (“User Login”) and one for new users (“Create User Login”). New users must create a user account before they can access the Negotiation/Meditation/Arbitration processes. The new user is required to provide the ODR System Program with contact and identity information (for example, business name, telephone number, postal address, email address). After receiving necessary information from the new user, the ODR System Program creates a new user account for the user which provides the merchant with private Web space (hereafter, “merchant private Web space”) on the ODR System Web site. The merchant private Web space centralizes the information and control required to perform Negotiation/Meditation/Arbitration processes; this may include case status information, access and delivery of electronic forms, and hyperlink commands to execute procedures in furtherance of Negotiation/Meditation/Arbitration processes. If the First Merchant elects to proceed after reviewing the information provided in stage 702, then the ODR System Program creates a new user account in stage 704. Existing users do not need to create a new account, and instead may hyperlink to a user login page to access their account as described in the next stage 706. The new user in stage 704 provides additional information regarding the new user's preferred method of communication (e.g., fax, email) and “news” preferences. (The ODR System Program will offer news updates to users who wish to receive them; in some embodiments, the news will convey current status information for a party's pending disputes.) The ODR System Program processes the information and assigns a unique access-key, such as a username and password, to the new user for access to user's private Web space on the ODR System Web site.

In stage 706, the First Merchant accesses its user's Web space with its unique access-key, and is presented with an Negotiation/Meditation/Arbitration Start Page; the Negotiation/Meditation/Arbitration Start Page provides a multi-page online Application Form which is completed by the First Merchant and created dynamically by the ODR System Program in response to information provided by the First Merchant. In particular, the First Merchant is initially presented with a short series of questions (or option buttons) to answer (or select), which the First Merchant performs and submits to the ODR System Program in stage 708. The ODR System Program then determines what types of Negotiation/Meditation/Arbitration processes the First Merchant has selected; selections may include—individually or in combination—the Negotiation System 144, the Mediation System 146, or the Arbitration System 148 (FIG. 2B). In some embodiments, the First Merchant may also select whether a Contact Clause governs the particular dispute at issue and legally binds the parties to Negotiation/Meditation/Arbitration resolutions. On the basis of the Negotiation/Meditation/Arbitration processes selected by the First Merchant, the ODR System Program dynamically constructs the remainder of the Application Form in the user's private Web space in accordance with the First Merchant selections. Additional information required by the Application Form may include detailed information about the dispute, and any characteristics the First Merchant prefers in the selection of suitable mediators and arbitrators. The ODR System Program ensures in stage 710 that the Application Form is properly completed. In stage 712, the ODR System Program determines whether the Application Form has been validly completed; if it has not been validly completed (e.g., it is missing material information), then the ODR System Program sends a notice to the First Merchant of the deficiency and returns process to stage 714. If the ODR System Program determines that the Application Form was validly completed, then a notice of acceptance is sent to the First Merchant in stage 716.

In stage 718, the ODR System Program determines from the Application Form whether a Contact Clause binding the parties to Negotiation/Meditation/Arbitration procedures governs the dispute and designates the ODR System as the dispute resolution provider. In some embodiments, if a governing Contact Clause is indicated by the First Party, the ODR System Program assumes that the Contact Clause is valid against both parties; in some embodiments, an ODR System Clerk may conduct further investigation to ensure the validity of the Contact Clause against the parties. In stage 726, if the ODR System Program determines that a Contact Clause governs the dispute, then an email notification is sent to the Second Merchant regarding the initiation of Negotiation/Meditation/Arbitration processes against him. The email notice includes information regarding how to access the ODR System Web site to view information relating to the dispute, how to create a user account (if the Second Merchant is a new user), and the time limit within which the Response Form must be completed. If the ODR System Program determines that a Contact Clause does not govern the dispute, then in stage 720 an email notice of the initiated Negotiation/Meditation/Arbitration processes is sent to the Second Merchant with instructions to answer the First Merchant allegations within a pre-determined time period. The email notice additionally requests the Second Merchant to voluntarily participate in the Negotiation/Meditation/Arbitration processes, and provides background information to assist the Second Merchant in deciding to participate. In stage 722, the ODR System Program waits for a pre-determined time period for the Second Merchant to send an answer. In stage 730, the ODR System Program receives the answer and determines from the received message whether the Second Merchant has agreed to voluntarily participate in Negotiation/Meditation/Arbitration processes; if the pre-determined time period expires prior to receipt of the Second Merchant answer, then the ODR System Program terminates the proceedings in stage 734. If the Second Merchant answer indicates its decision to voluntarily participate in Negotiation/Meditation/Arbitration processes, then in stage 736 the ODR System Program notifies the parties that Negotiation/Meditation/Arbitration processes have initiated to resolve their dispute in accordance with their express agreement; the email notification sent to the Second Party includes a Response Form that the Second Party must complete within a specified time-period.

In stage 738, the Second Merchant submits the requested information in the Response Form to the ODR System Program; requested information in the Response Form includes information about the dispute, the Second Merchant's preferred mediator/arbitrator characteristics (used during selection of mediators and arbitrators), and counter-claims (in the arbitration process), if any. If the Second Merchant makes a counterclaim, it will be required to estimate the value of the claim. The ODR System Program will assess fees from the Second Merchant as a proportion of this value. In stage 740, the ODR System Program conducts an administrative review of all case-related information. The administrative review includes determining whether the relevant forms (i.e., the Application Form and the Response Form) were properly completed, and whether the parties have made proper payment for the DR services. If the administrative review is successful, the ODR System Program changes the status of the case to “In Progress,” and sends email notifications to the parties that the case is proceeding; otherwise, in stage 744, the ODR System Program System identifies the deficiency and sends an email notice with instructions to correct the deficiency to the relevant party. In stage 742, the ODR System Program has determined after administrative review that the case is ready to proceed, and in stage 748 sends a notice to the parties that Negotiation/Meditation/Arbitration processes have initiated. After stage 748, the parties enter the negotiation process 751, the mediation process 757, and the arbitration process 771, or some combination of the three; the particular combination of ODR processes applied by the ODR System Program depends upon the express agreement of the parties as determined by the ODR System Program in prior stages.

In the illustrative embodiment of FIG. 4A, the first ODR phase the ODR System Program initiates is the negotiation process 751. In stage 750, the ODR System Program determines whether the parties agreed to engage the negotiation process. If the parties did not agree to a negotiation process, then the ODR System Program initiates the mediation process 757; otherwise, the ODR System Program conducts the negotiation process in stage 752. In stage 754, the ODR System Program determines whether the parties reached agreement after the negotiation process. If an agreement was reached, then in stage 782 the ODR System Program constructs an Agreement Form reciting the agreement reached, which it then sends to the parties for approval. The ODR System Program then closes the case in stage 764.

In the mediation process, the ODR System Program determines in stage 756 whether the parties selected to engage in the mediation process. If the parties did not select mediation, then the ODR System Program initiates the arbitration process 771; otherwise, the ODR System Program conducts the mediation process in stage 758. The ODR System Program determines whether an agreement was reached by the parties in stage 760. If an agreement was reached, the ODR System Program constructs an Agreement Form reciting the agreement reached, which it then sends to the parties for approval. The ODR System Program then closes the case in stage 764.

In the arbitration process, the ODR System Program determines in stage 770 whether the parties selected to engage in the arbitration process. If the parties did not select arbitration, then the ODR System dismissed the case in stage 776, and terminates all processes related to the case in stage 780; otherwise, the ODR System Program conducts the arbitration process in stage 772. In stage 774, the ODR System Program determines whether an award was granted by the arbitrator (note that more than one arbitrator may be assigned to the case). If an award was granted, the ODR System Program closes the case in stage 764. If not award is granted by the arbitrator, the ODR System Program dismisses the case in stage 776, and then terminates all processes related to the case in stage 780.

3. Mediator and Arbitrator Appointment Process

FIG. 4B is a flow diagram illustrating the stages in the mediator and arbitrator appointment process in the Negotiation/Meditation/Arbitration System, according to some embodiments of the invention. In stage 800, a prospective mediator or arbitrator accesses the ODR System Web site and is directed to an online Enrollment Form. In stage 802, the prospective mediator or arbitrator provides the information requested by the Enrollment Form; the information may include the mediator or arbitrator's field of expertise, geographic location, and language proficiency. In stage 804, the information provided on the Enrollment Form is stored by the ODR System Program and made accessible to the Selection Council. In stage 806, the Selection Council reviews the information from the Enrollment Form to determine whether the applicant qualifies as a suitable mediator and/or arbitrator. In stage 808, the mediators or arbitrators approved by the Selection Council are added to an arbitrator/mediator database maintained by the ODR System Program.

Stages 810 to 836 occur when the ODR System Program is required to appoint a new mediator or arbitrator to a case. In stage 810, the ODR System Program queries the arbitrator/mediator database for a suitable mediator or arbitrator based on pre-determined criteria which may include the mediator's or arbitrator's language, geographic location, and field of expertise. The ODR System Program detects a suitable mediator or arbitrator by matching the characteristics of the case subject matter and the parties' preferred characteristics with the characteristics of the arbitrators/mediations in the arbitrator/mediator database. In stage 812, the ODR System Program selects a mediator or an arbitrator and evaluates whether the selected mediator/arbitrator's work schedule permits proper performance in the case. In stage 814, after matching characteristics and determining availability, the ODR System Program selects the mediator/arbitrator and sends an email notice regarding his or her selection. In stage 816, the mediator/arbitrator must examine the information relating to the case to determine whether he or she is sufficiently independent of the dispute and the parties to undertake the appointment. The mediator/arbitrator submits a declaration of independence to the ODR System Program before he or she may accept the appointment. The mediator or arbitrator must accept or reject the appointment within a certain time frame. In stage 818, the ODR System Program determines whether the mediator/arbitrator accepted the appointment within a specified time frame; if the time expired for submitting the acceptance (or the mediator/arbitrator refused the appointment), then the ODR System Program returns to stage 810 to select a new mediator/arbitrator. Stages 810 through to 818 are repeated until a mediator or arbitrator accepts the appointment; in some embodiments, a panel of mediators or arbitrators may be appointed, requiring further repetitions of stages 810 to 818.

In stage 822, the ODR System Program sends an email notification of the mediator/arbitrator appointment to the First Merchant and the Second Merchant. In stage 824, either party may at any time challenge the appointment of the mediator/arbitrator. If no challenge is issued by the parties to the mediator/arbitrator appointment, then the appointment is finalized in stage 836; otherwise, in stage 826, the challenging party completes an online form indicating its rationale for challenging the appointment. The Selection Council accesses the challenging party's rationale, and in stage 828 analyzes their merit. In stage 830, the Selection Council notifies the parties and the challenged mediator/arbitrator of its decision. In stage 832, if the Selection Council adopts the challenge, then the challenged mediator/arbitrator is dropped from the case and a new mediator/arbitrator is appointed in stages 810 through 818; otherwise, the challenged mediator/arbitrator appointment is finalized in stage 836.

We claim:

1. A method of providing integrated dispute resolution services over a computer network for resolving a dispute between a first party and a second party, comprising:
distributing a Web site over the computer network;
negotiating a first solution using the Web site;
mediating a second solution using the Web site; and
arbitrating a third solution using the Web site.

2. The method of claim 1, further comprising:
performing the negotiation before the mediation; and
performing the mediation before the arbitration.

3. The method of claim 1, further comprising establishing an agreement between the second party and the owner of the dispute resolution services to accept the third solution in exchange for access to the dispute resolution services.

4. The method of claim 1, wherein the first party includes one or more customers of the second party, including one or more individuals or corporate entities, and the second party includes one or more merchants, including one or more individuals or corporate entities.

5. The method of claim 1, further comprising providing a link to the second party for display on the second party's Web site, wherein the link provides access to the dispute resolution services on the Web site and operates to identify the dispute resolution services.

6. The method of claim 5, wherein the link operates as a hyperlink to the dispute resolution services on the Web site.

7. The method of claim 5, wherein the link operates as a trademark.

8. The method of claim 5, wherein the link includes a unique identifier identifying the second party using the link.

9. The method of claim 8, further comprising determining the second party to the dispute using the link.

10. The method of claim 5, further comprising:
determining whether the first party accessed the Web site via the link;
if the first did not access the Web site via the link, then providing to the first party a list of merchant-partners; and
receiving a selection from the first party of the second party to the dispute from the list of merchant-partners.

11. The method of claim 1, wherein negotiating the first solution includes:
receiving application information from the first party, including one or more proposed solutions to the dispute;
providing the application information to the second party;
receiving an agreement from the second party to one of the first party proposed solutions; and
establishing a first solution based on the second party agreement.

12. The method of claim 9, wherein receiving the second party agreement occurs on or within seven days.

13. The method of claim 9, wherein negotiating the first solution further includes:
if the first solution is not accepted by the parties, then:
receiving response information from the second party in response to the application information, including one or more proposed solutions to the dispute;
providing the second party response information to the first party;
receiving an agreement from the first party to one of the second party proposed solutions; and
establishing the first solution based on the first party agreement.

14. The method of claim 11, wherein receiving the first party agreement occurs on or within ten days.

15. The method of claim 1, wherein mediating the second solution includes:
appointing a mediator to mediate the dispute;
providing information relating to the dispute to the mediator;
receiving one or more solutions to the dispute proposed by the mediator;
providing the proposed mediator solutions to the parties;
receiving a response from each party, including a proposed mediator solution acceptable to each party;
determining whether the parties agreed on the acceptable proposed mediator solution; and
establishing a second solution based on the acceptable proposed mediator solution.

16. The method of claim 13, wherein the proposed mediator solutions are provided to the parties on or within sixteen days of receiving the application information.

17. The method of claim 13, wherein the parties' response to the proposed mediator solutions is received on or within nineteen days of receiving the application information.

18. The method of claim 13, wherein the acceptable proposed mediator solution is determined from a ranking of the proposed mediator solutions by each party in order of acceptability.

19. The method of claim 13, wherein determining whether the parties agreed on the acceptable proposed mediator solution is automated.

20. The method of claim 1, wherein arbitrating the third solution includes automatically generating a third solution based on the proposed mediator solutions and the parties' responses to the proposed mediator solutions.

21. The method of claim 1, wherein arbitrating the third solution includes:
providing information relating to the dispute to the mediator;
receiving a proposed final solution determined by the mediator; and
establishing the third solution based on the proposed final solution.

22. The method of claim 19, wherein the proposed final solution is provided to the parties on or within twenty days of receiving the application information.

23. The method of claim 19, wherein the parties' response to the proposed final solution is received on or within twenty-three days of receiving the application information.

24. The method of claim 19, wherein the third solution is provided to the parties on or within twenty-four days of receiving the application information.

25. The method of claim 1, further comprising:
receiving a proposed solution to the dispute from one of the parties at anytime during the dispute resolution process;
providing the proposed solution to the other party;
receiving an agreement by the other party to the proposed solution; and
establishing a fourth solution based on the other party's agreement.

26. A computer system for providing integrated dispute resolution services over a computer network for resolving a dispute between a first party and a second party, comprising:
at least one server computer connected to the computer network; and
a computer program executed by the server computer, wherein the computer program further comprises computer instructions for:
distributing a Web site over the computer network;
negotiating a first solution using the Web site;
mediating a second solution using the Web site; and
arbitrating a third solution using the Web site.

27. The computer system of claim 26, wherein the computer program further comprises computer instructions for:
performing the negotiation before the mediation; and
performing the mediation before the arbitration.

28. The computer system of claim 26, wherein the computer program further comprises computer instructions for determining the second party to the dispute using a link.

29. The computer system of claim 26, wherein the computer program further comprises computer instructions for:
determining whether the first party accessed the Web site via the link;
if the first did not access the Web site via the link, then providing to the first party a list of merchant-partners; and
receiving a selection from the first party of the merchant-partner to the dispute from the list of merchant-partners.

30. The computer system of claim 26, wherein the computer instructions for negotiating the first solution includes computer instructions for:
receiving application information from the first party, including one or more proposed solutions to the dispute;
providing the application information to the second party;
receiving an agreement from the second party to one of the first party proposed solutions; and
establishing a first solution based on the second party agreement.

31. The computer system of claim 30, wherein the computer instructions for negotiating the first solution further includes computer instructions for terminating the negotiation if the second party agreement is received after the seventh day from the date of receiving the application information.

32. The computer system of claim 30, wherein the computer instructions for negotiating the first solution further includes computer instructions for:
if the first solution is not accepted by the parties, then:
receiving response information from the second party in response to the application information, including one or more proposed solutions to the dispute;
providing the second party response information to the first party;
receiving an agreement from the first party to one of the second party proposed solutions; and
establishing the first solution based on the first party agreement.

33. The computer system of claim 30, wherein the computer instructions for negotiating the first solution further includes computer instructions for terminating the negotiation if the first party agreement is received after the eleventh day from the date of receiving the application information.

34. The computer system of claim 26, wherein the computer instructions for mediating the second solution include computer instructions for:
appointing a mediator to mediate the dispute;
providing information relating to the dispute to the mediator;
receiving one or more solutions to the dispute proposed by the mediator;
providing the proposed mediator solutions to the parties;
receiving a response from each party, including a proposed mediator solution acceptable to each party;
determining whether the parties agreed on the acceptable proposed mediator solution; and
establishing a second solution based on the acceptable proposed mediator solution.

35. The computer system of claim 34, wherein the computer instructions for mediating the first solution further includes computer instructions for terminating the mediation if the parties' responses to the proposed mediator solutions are received after the nineteenth day of receiving the application information.

36. The computer system of claim 34, wherein the computer instructions for mediating the first solution further includes computer instructions for determining the acceptable proposed mediator solution from a ranking of the mediator proposed solutions by each party in order of acceptability.

37. The computer system of claim 34, wherein the computer instructions for arbitrating the third solution includes computer instructions for automatically generating a third solution based on the proposed mediator solutions and the parties' responses to the proposed mediator solutions.

38. The computer system of claim 34, wherein the computer instructions for arbitrating the third solution includes computer instructions for:
providing information relating to the dispute to the mediator;
receiving a proposed final solution determined by the mediator; and
establishing the third solution based on the proposed final solution.

39. The computer system of claim 38, wherein the computer instructions for arbitrating the third solution further includes computer instructions for terminating the arbitration if the parties' response to the proposed final solution is received after twenty-three days of receiving the application information.

40. The computer system of claim 26, further comprising computer instructions for:
receiving a proposed solution to the dispute from one of the parties at anytime during the dispute resolution process;
providing the proposed solution to the other party;
receiving an agreement by the other party to the proposed solution; and
establishing a fourth solution based on the other party's agreement.

41. A method of providing integrated dispute resolution services over a computer network for resolving a dispute between a first party and a second party, comprising:
distributing a Web site over the computer network;
negotiating a first solution using the Web site;
mediating a second solution using the Web site;
arbitrating a third solution using the Web site;
wherein negotiating the first solution includes:
receiving application information from the first party, including one or more proposed solutions to the dispute;
providing the application information to the second party;
receiving an agreement from the second party to one of the first party proposed solutions; and
establishing a first solution based on the second party agreement;
if the first solution is not accepted by the parties, then:
receiving response information from the second party in response to the application information, including one or more proposed solutions to the dispute;
providing the second party response information to the first party;
receiving an agreement from the first party to one of the second party proposed solutions; and
establishing the first solution based on the first party agreement;
wherein mediating the second solution includes:
appointing a mediator to mediate the dispute;
providing information relating to the dispute to the mediator;
receiving one or more solutions to the dispute proposed by the mediator;
providing the proposed mediator solutions to the parties;
receiving a response from each party, including a proposed mediator solution acceptable to each party;
determining whether the parties agreed on the acceptable proposed mediator solution; and
establishing a second solution based on the acceptable proposed mediator solution; and
wherein arbitrating the third solution includes:
providing information relating to the dispute to the mediator;
receiving a proposed final solution determined by the mediator;
establishing the third solution based on the proposed final solution.

42. A computer data signal embodied in a carrier wave for providing integrated dispute resolution services over a computer network for resolving a dispute between a first party and a second party, the signal comprising data generated by:
distributing a Web site over the computer network to the first party and the second party;
negotiating a first solution using the Web site;
mediating a second solution using the Web site; and
arbitrating a third solution using the Web site.
